(19) United States
(12) Patent Application Publication
(10) Pub. No.: US 2009/0279168 A1
(43) Pub. Date: Nov. 12, 2009

(54) ADHESIVE COMPOSITION FOR OPTICAL FILTER, OPTICAL FILTER AND DISPLAY DEVICE

(76) Inventors: Yuka Hiwatashi, Tokyo-to (JP); Toshio Yoshihara, Tokyo-to (JP); Yudai Yamashita, Tokyo-to (JP); Hiroyuki Ohtaki, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 12/441,760

(22) PCT Filed: Sep. 28, 2007
(86) PCT No.: PCT/JP2007/069063

§ 371 Date: Mar. 18, 2009

(30) Foreign Application Priority Data
Sep. 29, 2006 (JP) 2006-266570

(51) Int. Cl. G02B 5/20; C08L 53/00; C08K 5/3417; C08K 5/16

(52) U.S. Cl. 359/359; 524/505; 524/88; 524/186; 359/892

(57) ABSTRACT

The object of the invention is to provide an adhesive composition attaining, in a single layer, both adhesiveness capable of direct attachment to a glass plate disposed on the front face of a display device and desired optical filter functions and hardly undergoing the change in spectral characteristics attributable to deterioration in a light absorbing agent, even during long-time use, particularly at high temperature under high humidity, as well as an optical filter using this adhesive composition. The object is solved by an optical filter comprising an adhesive layer having optical filter functions, comprising a block copolymer (I) having at least a specific triblock structure in its molecule and having a weight average molecular weight of 50,000 or more and a molecular weight distribution (Mw/Mn) of less than 1.5, a resin (IV) having the glass transition temperature of 60° C. or more and one or more light absorbing agents (III) each having light absorption in a predetermined wavelength region.

### TECHNICAL FIELD

The present invention relates to an optical filter for being disposed on the front face of a display device, the optical filter having an adhesive layer cutting off an unnecessary light emitted from the display device or capable of adjusting a color tone; an adhesive composition for optical filter suitable to form the adhesive layer; and a display device using the optical filter.

### BACKGROUND ART

In recent years, as a display device for various electronic devices, CRT (cathode-ray tube), LCD (liquid crystal display), PDP (plasma display panel), an organic.inorganic EL display, FED (field emission display) or the like is used.

An optical filter is set on the front face of such a display device in order to remove unnecessary emission component and allow a display color to be clear. For example, in the plasma display, mixed gas of xenon and neon is excited by discharge to emit a vacuum ultraviolet light, and three primary colors emission is obtained using the emission of each phosphor in red, blue and green caused by the excitation of the vacuum ultraviolet light. The plasma display has disadvantages that vivid red color can not be obtained since an orange color mixes into a red color since a neon orange light (hereinafter, it may be referred to as a Ne light) around 590 nm is emitted after the neon atom is excited and returns to the ground state. On the other hand, besides the ultraviolet light, a near-infrared light (hereinafter, it may be referred to as NIR) in around 800 to 1,100 nm is generated after the xenon atom is excited and returns to the ground state, thereby, the generated near-infrared light may cause malfunctions to peripheral devices. Therefore, the plasma display is provided with a filter having a function that can absorb and remove the neon orange light and the near-infrared light, for example, a filter that locally decreases transmittance of wavelength of the neon orange light and the near-infrared light, at the front face of the display. Further, a function that corrects color balance of images or improve color purity by adjusting transmittance of visible light wavelength region may be imparted to the filter. A filter for achieving a variety of these filter functions, particularly a NIR absorption filter, has a problem that a dye contained in the filter is easily deteriorated by ultraviolet light (hereinafter, it may be referred to as UV) derived from sun light and so on. In order to solve the problem, a UV absorption function is also required.

As function and use of electrical and electronic devices increase, electromagnetic interference (EMI) has been increasing, and electromagnetic waves are generated even from the above-mentioned display devices such as PDP. Therefore, an electromagnetic wave shielding sheet (electromagnetic wave shielding filter) having an electromagnetic wave shielding function is generally provided on the front face of PDP or the like. A required shielding property against the electromagnetic wave generated from the front face of PDP is 30 dB or more in 30 MHz to 1 GHz. In the present specification, the term “electromagnetic wave” is used as an electromagnetic wave in frequency band region of around MHz to GHz or less and distinctly used from an infrared ray, a visible light and an ultraviolet light.

The electromagnetic wave shielding sheet of such purpose requires optical transparency as well as the electromagnetic wave shielding capability. Accordingly, an electromagnetic wave shielding sheet in which a metallic foil such as copper foil is attached to a transparent substrate film made of a resin film by a bonding agent and the metallic foil is etched to form an electroconductive mesh layer is known.

As a front-face filter which is disposed on the front face of the display, a composite filter in which a NIR absorption function, a Ne light absorption function, a color correction function, a UV absorption function and so on are unified together with the electromagnetic wave shielding function is often used.

For example, Patent document 1 and Patent document 2 disclose a composite filter, wherein an electroconductive mesh layer and further an adhesive layer for attachment to a display are formed on one surface of a transparent substrate film in this order, and a NIR absorbing filter film and so on are laminated on the other surface of the transparent substrate film. Patent document 3 discloses a composite filter having an electroconductive mesh layer which is obtained by laminating a metallic foil on one surface of a transparent substrate film via a bonding agent layer followed by etching, wherein a NIR absorbing dye is added in the bonding agent layer for attachment to a display, or a resin layer having the NIR absorbing dye added is formed on the back side.

Patent Document 4 describes an acrylic block copolymer composition characterized by: (i) comprising a block copolymer (I) having, in its molecule, at least a triblock structure wherein one polymer block (A1) based on acrylic ester units, and two polymer blocks (B1) different in structure from the polymer block (A1) and based on (meth)acrylic ester units, are bound to one another, or a triblock structure wherein two polymer blocks (A1) comprising acrylic ester units, and one polymer block (B1) different in structure from the polymer block (A1) and based on (meth)acrylic ester units, are bound to one another, the block copolymer (I) having a weight average molecular weight of 120,000 or more and a molecular weight distribution (Mw/Mn) of less than 1.5; and a diblock copolymer (II) wherein one polymer block (A2) based on acrylic ester units, and one polymer block (B2) different in structure from the polymer block (A2) and based on (meth)acrylic ester units, are bound to each other, the diblock copolymer (II) having a molecular weight distribution (Mw/Mn) of less than 1.5; (ii) the ratio of the block copolymer (I):the diblock copolymer (II) contained being 100:50 to 100:500 by mass, and it is described therein that this acrylic block copolymer composition is useful an adhesive composition. However, Patent Document 4 does not describe use of the composition for a display device, endowment thereof with optical filter functions, deterioration of a dye functioning as a light absorbing agent therein, or impact resistance thereof at all.

### [Patent Document 1] Japanese Patent Application Laid-Open (JP-A) No. 13-210988

### [Patent Document 2] JP-A No. 11-126024

### [Patent Document 3] Japanese Patent No. 3473310

### [Patent Document 4] JP-A No. 2005-307063

### [Patent Document 5] JP-A No. 2002-260539

### DISCLOSURE OF INVENTION

### Problems to be Solved by the Invention

As the size of display devices is growing and demand for reduction in weight and thickness of composite filters is increasing, it has been considered that if a single layer which can provide both adhesiveness capable of direct attachment to a front glass or the like of a display device or interlayer attachment, and an optical filter function such as a near-infrared light absorption function, a neon light absorption function a color tone adjusting function can be attained, the weight and thickness of the layer can be reduced, and in addition, the production process can be simplified and the production cost thereof can be reduced. Therefore, the embodiment of adding a dye in the bonding agent layer was proposed as disclosed in Patent document 3.

However, for example, in the method wherein a dye such as a NIR absorbing dye is added to a bonding agent layer (incidentally, a so-called adhesive is a form of the bonding agent) applied onto an electroconductive mesh surface, to attach a composite filter to the surface of a display, as shown in Patent Document 3, there has been a problem that the NIR absorbing dye reacts and changes color or discolors so as to change absorption spectral characteristic, that is, a problem of deterioration of the dye. This deterioration in the dye, though occurring when left after a long time even in a room-temperature atmosphere (ambient temperature about 10 to 20° C., relative humidity about 30 to 60%), will be promoted significantly in a high-temperature atmosphere (ambient temperature 50° C. or more) or in a high-temperature high-humidity atmosphere (ambient temperature 50° C. or more and relative humidity 70% or more). This tendency applies particularly to a NIR absorbing dye mainly using an organic dye based on diimmonium etc.

While some of the detailed parts are still unknown, the cause thereof is estimated to be the following two types of mechanisms of dye deterioration in the filter of such a constitution.

(1) [Interaction (chemical reaction) between a dye and each adjacent layer] Specifically, in the case that the dye is contained in the bonding agent layer contacting with the electroconductive mesh layer or glass, metal of the electroconductive mesh layer (in particular, a generally frequently-used transition metal element such as copper, iron or the like), a metallic compound constituting a blackened layer (in particular, a generally frequently-used compound of transition metal element such as copper, zinc, cobalt, nickel or the like), or a sodium ion in a glass plate of the display device which is an adherend directly reacts with the dye or indirectly accelerates the reaction between the dye and the bonding agent as a catalyst so as to change the absorption spectrum of the dye.

(2) [Interaction between a dye and a bonding agent] Specifically, components (particularly, atomic groups or functional groups) in the bonding agent to which the dye is to be added interact with (that is, chemically reacts with or catalytically acts on) the dye, to change a molecular structure of the dye followed by a change in energy level, thereby changing an absorption spectrum of the dye.

As described above, there has been a problem that when the conventionally used acrylic adhesive layer which functions as the adhesive layer contains the light absorbing agent (dye) having the near-infrared light absorption function, the neon light absorption function or the color tone adjusting function, the light absorbing agent (dye) deteriorates so as to change spectral characteristic as the optical filter, thus its practical use has been difficult.

In the case that adhesive layer is provided adjacent to the electroconductive mesh layer side of the electromagnetic wave shielding sheet having the electroconductive mesh layer, the electroconductive mesh layer surface of the electromagnetic wave shielding sheet may be discolored. For example, if the copper mesh layer surface is oxidized, the electromagnetic wave shielding sheet becomes blue so that the color reproducibility of the display device is adversely affected.

Patent Document 5 has proposed a plasma display panel comprising an optical filter with an antireflective film attached via an adhesive layer to the front face of a display, wherein the breaking energy thereof in an impact resistance test is 0.5 J or more, and it is described therein that impact resistance is conferred on, and a light absorbing agent such as a dye is added to, the adhesive layer. In the adhesive layer described in Patent Document 5, however, metal ions are crosslinked to form an ionomer resin, so the light absorbing agent is deteriorated with time to change its spectral characteristics, thus making its practical application problematic.

As described above, there has been a problem that when the conventionally used acrylic adhesive layer which functions as the adhesive layer contains the light absorbing agent (dye) having the near-infrared light absorption function, the neon light absorption function or the color tone adjusting function, the light absorbing agent (dye) deteriorates so as to change spectral characteristic as the optical filter, thus its practical use has been difficult.

In consideration of the above-mentioned problems, the present invention is to provide an optical filter having an adhesive layer which has both adhesiveness and desired optical filter function in a single layer, wherein a change in spectral characteristic attributable to deterioration of light absorbing agents is hardly caused even after long-term use, particularly at high temperature and high humidity, an adhesive composition capable of obtaining the adhesive layer, and a display device provided with the optical filter.

### Means for Solving the Problems

To solve the problem, the present invention provides an adhesive composition for optical filter, which comprises:

(I) a multiblock copolymer having, in its molecule, at least a triblock structure wherein one polymer block (A1) containing acrylic ester units, and two polymer blocks (B1) different in structure from the polymer block (A1) and containing (meth)acrylic ester units, are bound to one another, or a triblock structure wherein two polymer blocks (A1) containing acrylic ester units, and one polymer block (B1) different in structure from the polymer block (A1) and containing (meth)acrylic ester units, are bound to one another, and having a weight average molecular weight of 50,000 or more and a molecular weight distribution (Mw/Mn) of less than 1.5;

(II) a resin; and

(III) one or more light absorbing agents each having light absorption in a predetermined wavelength range,

wherein the resin (II) makes 0.015 or less both chromatic differences Δx and Δy of a film consisting of the adhesive composition, before and after left in an atmospheric environment at an ambient temperature of 80° C. and a relative humidity of 10% or less for 1,000 hours.

To solve the problem, the present invention also provides an adhesive composition for optical filter, which comprises:

(I) a multiblock copolymer having, in its molecule, at least a triblock structure wherein one polymer block (A1) containing acrylic ester units, and two polymer blocks (B1) different in structure from the polymer block (A1) and containing (meth)acrylic ester units, are bound to one another, or a triblock structure wherein two polymer blocks (A1) containing acrylic ester units, and one polymer block (B1) different in structure from the polymer block (A1) and containing (meth)acrylic ester units, are bound to one another, and having a weight average molecular weight of 50,000 or more and a molecular weight distribution (Mw/Mn) of less than 1.5;

(IV) resin having the glass transition temperature of 60° C. or more; and

(III) one or more light absorbing agents each having light absorption in a predetermined wavelength range.

Further, in order to achieve the above object, the present invention provides an optical filter for being disposed on the front face of a display device comprising an adhesive layer having optical filter function formed with the use of the adhesive composition for optical filter of the present invention.

According to the present invention, since one or more light absorbing agents (III) having light absorption in a predetermined wavelength range are used with the combination of the specific block copolymer (I) and the resin (II) or the resin (IV) having the glass transition temperature of 60° C. or more, the advantage can be obtained that change in spectral characteristic attributable to deterioration of light absorbing agents even after long-term use, particularly at high temperature and high humidity, is hardly caused while the adhesive layer alone can provide both adhesiveness capable of a direct attachment to a glass plate disposed on the front face of a display device and desired optical filter function. Since the specific block copolymer (I) and one or more light absorbing agents (III) having light absorption in a predetermined wavelength range are used, the advantage can be obtained that change in spectral characteristic attributable to deterioration of light absorbing agents even after long-term use, particularly at high temperature and high humidity, is hardly caused while the adhesive layer alone can provide both adhesiveness and desired optical filter function. However, when the specific block copolymer (I) and the resin (II) or the a resin (IV) having the glass transition temperature of 60° C. or more are combined and used, the advantage can be obtained that change in spectral characteristic attributable to deterioration of light absorbing agents even at high temperature and high humidity, is further hardly caused.

In the adhesive composition and the adhesive layer of the optical filter according to the present invention, it is preferable that from 3 to 50 parts by weight of the resin (II) or the resin (IV) having the glass transition temperature of 60° C. or more are contained with respect to 100 parts by weight of the multiblock copolymer (I) from the viewpoint of obtaining the effect which further hardly causes change in spectral characteristic attributed to deterioration of light absorbing agents even at high temperature and high humidity.

Also, it is preferable that the adhesive composition and the adhesive layer of the optical filter according to the present invention contain a light absorbing agent having an absorption band region at least in the wavelength from 800 to 1,100 nm from the viewpoint of obtaining the optical filter that can absorb and remove near-infrared light ray to locally decrease transmission of a wavelength of near-infrared light.

In the adhesive composition and the adhesive layer of the optical filter according to the present invention, it can be contained a phthalocyanine-based compound and/or a diimmonium-based compound as the light absorbing agent having an absorption band region at least in the wavelength from 800 to 1,100 nm. In particular, the diimmonium-based compound is a preferable compound as a near-infrared light absorbing agent from the viewpoint of a large absorption in the near-infrared region, a wide absorption range and a high transmittance in the visible region. However, conventionally, it has been very difficult to contain the diimmonium-based compound in an adhesive because of its easy deterioration after long-term use, particularly at high temperature and high humidity. In the combination of the above-specified block copolymer (I) and resin (II) or the resin (IV) having the glass transition temperature of 60° C. or more according to the present invention, it can be prevented from being deteriorated even at high temperature and high humidity and can thus preferably be used as a near-infrared light absorbing agent.

In the adhesive composition and the adhesive layer of the optical filter according to the present invention, it is preferable that the resin (II) or the resin (IV) having the glass transition temperature of 60° C. or more satisfies 5% or less of haze value in accordance with JIS K7105-1981 of a coating film with a film thickness of 25 μm formed of a mixture mixed in a range from 3 to 50 parts by weight of the resin (II) or the resin (IV) having the glass transition temperature of 60° C. or more with respect to 100 parts by weight of the multiblock copolymer (I). The transparency as the optical filter can be ensured by selecting the multiblock copolymer (I) and the resin (II) or the resin (IV) having the glass transition temperature of 60° C. or more having a good compatibility therebetween.

In the adhesive composition and the adhesive layer of the optical filter according to the present invention, it is preferable an acid number of the resin (II) and the resin (IV) having the glass transition temperature of 60° C. or more is 30 or less from the viewpoint of preventing deterioration of light absorbing agents.

In the adhesive composition and the adhesive layer of the optical filter according to the present invention, it is preferable the resin (II) or the resin (IV) having the glass transition temperature of 60° C. or more is one or more resins selected from the group consisting of an acrylic resin, an ester resin, an acrylic ester resin, a styrene resin, a polyvinyl resin and a polycarbonate resin from the viewpoint of ensuring transparency as the optical filter.

In the adhesive composition and the adhesive layer of the optical filter according to the present invention, the resin (II) or the resin (IV) having the glass transition temperature of 60° C. or more is a resin having a (meth)acrylic ester unit which forms a block structure of the multiblock copolymer (I) from the viewpoint of ensuring transparency as the optical filter.

In the adhesive composition and the adhesive layer of the optical filter of the present invention, it is preferable to contain a light absorbing agent having an absorption band region at least in the wavelength from 570 to 610 nm from the viewpoint of suppressing orange color emission at least from a display and being capable of obtaining vivid red color.

In the adhesive composition and the adhesive layer of the optical filter according to the present invention, it is preferable to contain a light absorbing agent having an absorption band region at least in the wavelength from 380 to 570 nm or 610 to 780 nm from the viewpoint of imparting functions such as correcting color balance of images and improving chromatic purity by adjusting transmittance in the wavelength range of visible light.

In the optical filter according to the present invention, it is preferable that further, one or more functional layers having one or more functions selected from the group consisting of an electromagnetic wave shielding function, an antireflection function, an antiglare function, a UV absorption function and a surface protection function are laminated on the adhesive layer having the optical filter function.

In the optical filter according to the present invention, it is preferable a transmittance in the wavelength range from 800 to 1,100 nm is 30% or less from the viewpoint of an effect to shield near-infrared light which is emitted from inside of a display and may cause malfunction in other machines.

In the optical filter according to the present invention, it is preferable that a transmittance of the maximum absorption wavelength in the wavelength range from 570 to 610 nm is 50% or less from the viewpoint of an effect to shield neon which is emitted from inside of a display and affects color tone.

In the optical filter according to the present invention, it is preferable that all light transmittance is 30% or more from the viewpoint of obtaining an optical filter having high transparency and low decrease in image contrast in the presence of outside light.

### EFFECT OF THE INVENTION

Effect of the adhesive composition according to the present invention is to provide an adhesive layer that can attain, in a single layer, both adhesiveness capable of a direct attachment to a glass plate and desired optical filter function, that hardly causes change in spectral characteristic attributable to deterioration of light absorbing agents even after long-term use, particularly at high temperature and high humidity, and that can simplify and reduce cost of production process. The adhesive composition according to the present invention can also prevent discoloration of an electroconductive mesh surface of electromagnetic wave shielding sheet even in the case that the adhesive layer is provided adjacent to the electroconductive mesh surface of the electromagnetic wave shielding sheet having an electroconductive mesh layer.

Further, since the optical filter according to the present invention comprises the adhesive layer formed with the use of the adhesive composition according to the present invention exhibiting both adhesiveness and desired optical filter function with a single layer, a production process can be simplified and cost of the process can be reduced. In addition, change in spectral characteristic attributable to deterioration of light absorbing agents after long-term use, particularly at high temperature and high humidity, is hardly caused, thus a stability of spectral characteristic is excellent. Compared to a conventional optical filter directly attached to a display surface of a plasma display panel, the optical filter according to the present invention can simplify a layer structure, reduce its weight and thickness of layer, thus, the production process can be simplified and the production cost thereof can be reduced.

Since the display device according to the present invention is provided with the optical filter according to the present invention, the display device according to the present invention can reduce its weight and thickness of layer, thus the production process can be simplified and the production cost thereof can be reduced.

### BRIEF DESCRIPTION OF THE DRAWINGS

FIG. 1 is a view showing an example of a laminate structure of an optical filter of the present invention.

FIG. 2 is a view showing an example of a laminate structure in the case that an optical filter of the present invention is directly attached to the front face of a plasma display panel.

FIG. 3 is a view showing another example of a laminate structure of an optical filter of the present invention.

FIG. 4 is a plan view of an example of an electromagnetic wave shielding sheet of the present invention.

FIG. 5 is a graph showing amounts of change in ΔE*ab with time regarding Example 1 and Comparative Example 1.

### DESCRIPTION OF SYMBOLS

1: adhesive layer having optical filter function
2: electromagnetic wave shielding layer
3: adhesive layer
4: antireflective layer
5: glass plate
10: optical filter
11: transparent substrate
12: electroconductive mesh layer
13: blackening treatment
20: plasma display panel
121: mesh area
122: earthing area

### BEST MODE FOR CARRYING OUT THE INVENTION

The present inventions include an adhesive composition for optical filter, an optical filter comprising an adhesive layer formed with the use of the adhesive composition and a display device using the optical filter. Hereinafter, each invention will be described.

I. Adhesive Composition for Optical Filter

An adhesive composition for optical filter according to the present invention comprises:

(I) a multiblock copolymer having, in its molecule, at least a triblock structure wherein one polymer block (A1) containing acrylic ester units, and two polymer blocks (B1) different in structure from the polymer block (A1) and containing (meth)acrylic ester units, are bound to one another, or a triblock structure wherein two polymer blocks (A1) containing acrylic ester units, and one polymer block (B1) different in structure from the polymer block (A1) and containing (meth)acrylic ester units, are bound to one another, and having a weight average molecular weight of 50,000 or more and a molecular weight distribution (Mw/Mn) of less than 1.5;

(II) a resin; and

(III) one or more light absorbing agents each having light absorption in a predetermined wavelength range,

wherein the resin(II) makes 0.015 or less both chromatic differences Δx and Δy of a film consisting of the adhesive composition, before and after left in an atmospheric environment at an ambient temperature of 80° C. and a relative humidity of 10% or less for 1,000 hours.

The film consisting of the adhesive composition used as a test sample for obtaining the chromatic difference can be, for example, prepared as follows: the adhesive composition is coated on a release-treated polyethylene terephthalate (PET) (for example, E7002 (product name, manufactured by Toyobo Co., Ltd.)) so that a film thickness when dried is 25 μm; the release-treated PET is laminated after appropriate drying so as to form a film; the film is attached to a glass (for example, PD-200 (product name, manufactured by Asahi Glass Co., Ltd., thickness of 2.8 mm)); a PET film (for example, A4100 (product name, manufactured by Toyobo Co., Ltd., thickness of 50 μm)) is laminated thereon; and thus a test sample is prepared.

An adhesive composition for optical filter according to the present invention comprises:

(I) a multiblock copolymer having, in its molecule, at least a triblock structure wherein one polymer block (A1) containing acrylic ester units, and two polymer blocks (B1) different in structure from the polymer block (A1) and containing (meth)acrylic ester units, are bound to one another, or a triblock structure wherein two polymer blocks (A1) containing acrylic ester units, and one polymer block (B1) different in structure from the polymer block (A1) and containing (meth)acrylic ester units, are bound to one another, and having a weight average molecular weight of 50,000 or more and a molecular weight distribution (Mw/Mn) of less than 1.5;

(IV) a resin having the glass transition temperature of 60° C. or more; and

(III) one or more light absorbing agents each having light absorption in a predetermined wavelength range.

According to the present invention, since one or more light absorbing agents (III) having light absorption in a predetermined wavelength range are used with the combination of the specific block copolymer (I) and the resin (II) or the resin (IV) having the glass transition temperature of 60° C. or more, the effect can be obtained that change in spectral characteristic attributed to deterioration of light absorbing agents even after long-term use, particularly at high temperature and high humidity, is hardly caused while the adhesive layer alone can provide both adhesiveness capable of a direct adhesion to a glass plate and desired optical filter function and that simplification of the production process and reduction in production cost are possible.

By using a combination of the specific block copolymer (I) and one or more light absorbing agents (III) having light absorption in a predetermined wavelength range, the effect can be obtained that change in spectral characteristic attributed to deterioration of light absorbing agent even after long-term use, particularly at high temperature and high humidity, is hardly caused while the adhesive layer alone can provide both adhesiveness and desired optical filter function. However, further by using a combination of the specific block copolymer (I) and the specific resin (II) or the specific resin (IV) with glass transition temperature of 60° C. or more as a binder for dispersing light absorbing agent (III) in the present invention, the effect can be obtained that change in spectral characteristic attributed to deterioration of light absorbing agent even at high temperature and high humidity is further hardly caused as compared with using the specific block copolymer (I) alone.

Specifically, for example, a layer of an adhesive composition [W] which is a combination of the specific block copolymer (I), the resin (IV) having the glass transition temperature of 60° C. or more and the diimmonium-based compound as a light absorbing agent which easily deteriorates, and a layer of an adhesive composition [Z] which is a combination of the specific block copolymer (I) and the diimmonium-based compound are prepared, and an amount of color variation ΔE*ab of each layer before and after left in an atmosphere at an ambient temperature of 80° C. and a relative humidity of 10% or less for 1,000 hours is measured. When the ΔE*ab values of the adhesive composition [W] and the adhesive composition [Z] are compared, the adhesive composition [W] of the present invention can reduce the value by 30% or more with respect to the value of the adhesive composition [Z]. Similarly, chromatic differences Δx and Δy of each layer consisting of each adhesive composition before and after left in an atmosphere at an ambient temperature of 60° C. and a relative humidity of 90% for 1,000 hours are measured. When the Δx and Δy values of the adhesive composition [W] and the adhesive composition [Z] are compared, the adhesive composition [W] of the present invention can reduce the values by 10% or more with respect to the values of the adhesive composition [Z].

ΔE*ab can be obtained by the following formula:

ΔE*ab={(ΔL*)²+(Δa*)²+(Δb*)²}^{1/2}

wherein, ΔL*, Δa* and Δb* respectively refer to the difference of value of L*, a* and b* of the surface of the adhesive layer before and after the layer is left in the specific atmosphere for the specific hours; and L*, a* and b* are values in L*a*b* color system recommended by the International Commission on Illumination (CIE) in 1976 and also defined in JIS Z8729.

The adhesiveness capable of a direct attachment to a glass plate disposed on the front face of a display device or an interlayer attachment is required to have so-called stickiness, which is adhesiveness of such a degree that no peeling and no slippage is generated under its weight or weak external force so that semipermanent use is capable and that a relatively easy peeling from a smooth surface is possible even after attachment if intentional force strong enough to exceed its weight is applied to peel. Particularly, in case of directly attaching the adhesive layer to a glass plate on the front face of a display device, removability is required so as to be able to reuse the display device and the glass substrate after peeling (hereinafter, this property may be referred to as “reworkability”). As the glass plate to be disposed on the front face of a display device, specifically, there may be a shield glass plate of a display device body, a glass substrate which is used for a filter separate from a display device, or the like.

The adhesive layer providing both adhesiveness capable of a direct attachment to a glass plate disposed on the front face of a display device and desired optical filter function with a single layer has advantages that, upon forming an optical film, a layer structure can be simplified, the weight of the optical filter can be reduced, the thickness of layer can be reduced, thus, the production process can be simplified and the production cost thereof can be reduced. However, when material having the adhesiveness capable of direct attachment to a glass plate or interlayer attachment is selected and a light absorbing agent which can attain a desired optical filter function is contained therein, the light absorbing agent easily deteriorates after a long-term use, particularly at high temperature and high humidity. Hence, it has been a problem that practical application of an adhesive layer having high stability of the optical filter function is difficult. For example, an adhesive layer often contains reactive monomers such as a crosslinking agent so as to give excellent adhesiveness and film-forming property, but when such highly reactive monomers are contained, a light absorbing agent such as a near-infrared light absorbing agent is significantly deteriorated.

In the present invention, on the other hand, since the specific block copolymer is further combined with specific resin and used as the resin in the adhesive layer, even if a light absorbing agent achieving desired optical functions is contained, the resulting adhesive layer can prevent the deterioration of the light absorbing agent caused by the interaction between the light absorbing agent and the adhesive, thus preventing the light absorbing agent from being deteriorated during use for a long time, particularly at high temperature under high humidity and attaining highly stable optical filter functions less liable to change spectral characteristics.

The block copolymer used in the adhesive layer of the present invention is a block copolymer having a specific triblock structure in its molecular and having a weight average molecular weight of 50,000 or more and a molecular weight distribution (Mw/Mn) of less than 1.5, thereby allowing the block copolymer to form a functional layer which hardly causes change in spectral characteristic attributed to deterioration of light absorbing agents even after long-term use, particularly at high temperature and high humidity, while the adhesive layer alone can provide both adhesiveness capable of a direct adhesion to a glass plate disposed on the front face of a display device and desired optical filter function. The reason for this achievement is not evident, but is estimated as follows.

That is, easy deterioration of a light absorbing agent in a conventional material having adhesiveness permitting direct attachment to a glass plate is considered attributable to formation of an ionomer resin by crosslinking metal ions, to incorporation of a highly reactive crosslinking agent, and to incorporation of highly reactive monomer and oligomer components.

On the other hand, the block copolymer (I) used in the present invention has a specific triblock structure in its molecule, and thus its formed coating is estimated to have a pseudo-crosslinked structure so as easily to form a microphase-separated structure, resulting not only in making it excellent in adhesiveness and film-forming property without adding a crosslinking agent but also in endowing it with impact resistance. The block copolymer (I) used in the present invention has a weight average molecular weight of 50,000 or more with a narrow molecular weight distribution (Mw/Mn) of less than 1.5 so that the adhesiveness and film-forming property are not deteriorated, and because highly reactive monomer and oligomer components are not contained, a light absorbing agent even when allowed to coexistent is estimated to be less liable to deterioration even during long-time use, particularly at high temperature under high humidity. Since such a specific block copolymer (I) is further blended with, for example, the resin (IV) having a relatively-high glass transition temperature and heat resistance property is increased, the light absorbing agent at high temperature hardly moves, and change in cohesion and dispersion state of the light absorbing agent is suppressed, so that a deterioration of the light absorbing agent is further suppressed.

As described above, since a specific block copolymer having a specific molecular weight and narrow molecular weight distribution is selected in the present invention, necessary adhesiveness and film-forming property can be realized without containing a crosslinking agent and the light absorbing agent can be prevented from being deteriorated due to a synergistic effect with the specific resin (II) or the resin (IV) with relatively-high glass transition temperature, thus making it possible to form a functional layer that hardly causes change in spectral characteristic attributed to deterioration of light absorbing agents even after long-term use, particularly at high temperature and high humidity while the adhesive layer alone can provide both adhesiveness capable of a direct adhesion to a glass plate disposed on the front face of a display device and desired optical filter function.

<Multiblock Copolymer Having a Specific Triblock Structure (I)>

The multiblock copolymer (I) as the essential component of the present invention comprises, in its molecule, any structure of the following {(I-a) or (I-b)} and has a weight average molecular weight of 50,000 or more and a molecular weight distribution (Mw/Mn) of less than 1.5.

(I-a) A triblock structure (A1)-(B1)-(B1) or (B1)-(A1)-(B1),

wherein one polymer block (A1) (also referred to simply as (A1) hereinafter) comprising acrylic ester units, and two polymer blocks (B1) (also referred to simply as (B1) hereinafter) different in structure from the polymer block (A1) and comprising (meth)acrylic ester units, are bound to one another.

(I-b) A triblock structure (A1)-(A1)-(B1) or (A1)-(B1)-(A1),

wherein two polymer blocks (A1) comprising acrylic ester units, and one polymer block (B1) different in structure from the polymer block (A1) and comprising (meth)acrylic ester units, are bound to one another.

As used herein, the term “(meth)acrylic ester unit” refers to an acrylic ester unit and/or a methacrylic ester unit.

Alternatively, the multiblock copolymers may be used alone but can be used as a mixture of two or more thereof in order to attain desired required performance more accurately or in a higher degree of freedom.

The multiblock copolymer may be:

a triblock copolymer consisting of one or two polymer blocks (A1) and one or more polymer blocks (B1): that is,

(A1)-(B1)-(B1),

(B1)-(A1)-(B1),

(A1)-(A1)-(B1) or

(A1)-(B1)-(A1), or may be:

a tetrablock or more block copolymer having one or two or more polymer blocks (C1), (C2), (C3) . . . (hereinafter, these polymer blocks are sometimes referred to collectively as “polymer block (C)”) bound to the aforesaid triblock copolymer: that is,

(A1)-(B1)-(B1)-(C),

(B1)-(A1)-(B1)-(C),

(A1)-(A1)-(B1)-(C) or

(A1)-(B1)-(A1)-(C).

In particular, the multiblock copolymer (I) is preferably a block copolymer having seven or less blocks, more preferably a triblock copolymer having three blocks (that is, the copolymer to which the polymer block (C) is not added), from the viewpoint of easy production, handling and ease in production.

In the triblock copolymer in (I-a) above represented by the formula (B1)-(A1)-(B1) and in the triblock copolymer in (I-b) above represented by the formula (A1)-(B1)-(A1), the two polymer blocks positioned at both ends (that is, (A1) and (A1) or (B1) and (B1)) may be the same or different insofar as they are different in structure from the polymer block positioned in the center.

It is necessary that in the triblock copolymer represented by the formula (A1)-(B1)-(B1) in (I-a) above or the formula (A1)-(A1)-(B1) in (I-b) above, the two polymer blocks adjacent to each other (that is, (A1) and (A1) or (B1) and (B1)) are different from each other in structure and also different in structure from another polymer block {that is, (B1) for (A1)-(A1), or (A1) for (B1)-(B1)}.

The phrase “the polymer blocks are different from each other in structure” shall satisfy the following condition: the polymer blocks are different from each other in the type, composition and/or stereoregularity of monomer units constituting each polymer block.

In the above acrylic block copolymer, the triblock copolymer represented by the formula (B1)-(A1)-(B1) in (I-a) is more preferably used because the adhesive (composition) is excellent in adhesive properties such as adhesion, cohesion and tackiness and also in heat resistance.

The polymer block (A1) constituting the multiblock copolymer is a polymer block consisting of an acrylic ester-based polymer comprising an acrylic ester-derived structural unit (acrylic ester unit).

The content, in the polymer block (A1) in the block copolymer, of the structural unit derived from an acrylic ester may be selected from structural units in the experimentally optimum range, depending on specific use, required performance, and other compounded components such as a light absorbing agent. In particular, the polymer block (A1) in the block copolymer preferably contains an acrylic ester-derived structural unit (acrylic ester unit) in a ratio of 50 weight % or more.

The acrylic ester unit constituting the polymer block (A1) is preferably a structural unit derived from an alkyl acrylate whose alkyl group may have a substituent and/or a cyclic alkyl acrylate whose cyclic alkyl group may have a substituent. Specific examples of the alkyl acrylate and cyclic alkyl acrylate include methyl acrylate, ethyl acrylate, n-propyl acrylate, isopropyl acrylate, n-butyl acrylate, isobutyl acrylate, sec-butyl acrylate, tert-butyl acrylate, n-hexyl acrylate, 2-ethylhexyl acrylate, dodecyl acrylate, tridecyl acrylate, stearyl acrylate, cyclohexyl acrylate, isobornyl acrylate, 2-methoxyethyl acrylate, 2-(N,N-dimethylamino)ethyl acrylate, trifluoromethyl acrylate, and trimethoxysilylpropyl acrylate. The polymer block (A1) can be formed from one or more of the above-described alkyl acrylates and cyclic alkyl acrylates.

In particular, it is preferable from the viewpoint of excellent adhesiveness of the resulting adhesive layer to a substrate that the polymer block (A1) is a block consisting of a polymer in which structural units derived from one or more alkyl acrylates having an alkyl group containing 4 or more carbon atoms, such as n-butyl acrylate, isobutyl acrylate, sec-butyl acrylate, tert-butyl acrylate, n-hexyl acrylate, 2-ethylhexyl acrylate, dodecyl acrylate, tridecyl acrylate and stearyl acrylate and from one or more alkyl acrylates whose alkyl group has a substituent, such as 2-methoxyethyl acrylate, 2-(N,N-dimethylamino)ethyl acrylate, trifluoromethyl acrylate, and trimethoxysilylpropyl acrylate are contained in a ratio of 50 weight % or more.

Particularly from the viewpoint of the water resistance of each polymer block, the polymer block (A1) is more preferably a block consisting of a polymer containing, in a ratio of 50 weight % or more, structural units derived from one or more members selected from n-butyl acrylate, n-hexyl acrylate, 2-ethylhexyl acrylate, dodecyl acrylate, tridecyl acrylate and stearyl acrylate, more preferably a polymer block consisting of a polymer containing, in a ratio of 50 weight % or more, structural units derived from n-butyl acrylate or 2-ethylhexyl acrylate.

The polymer block (A1) preferably contains an acrylic ester unit in a ratio of 50 weight % or more, more preferably 80 weight % or more, still more preferably 90 weight % or more, further more preferably 100 weight %, based on the weight of the polymer block (A1). When the ratio of the acrylic ester unit in the polymer block (A1) is less than 50 weight %, the adhesion and impact resistance of the resulting adhesive layer tend to be deteriorated, and the object of the present invention may hardly be achieved.

Other monomer units which are contained preferably in a ratio of 50 weight % or less, more preferably 20 weight % or less, still more preferably 10 weight % or less, in the polymer block (A1) in the block copolymer, include for example structural units derived from monomers such as alkyl methacrylates [for example, methyl methacrylate, ethyl methacrylate, isopropyl methacrylate, sec-butyl methacrylate, isobutyl methacrylate, tert-butyl methacrylate, cyclohexyl methacrylate, and other polymer block (B1)-forming methacrylates described later], methacrylamides such as methacrylamide, N-methylmethacrylamide, N-ethylmethacrylamide, N-isopropylmethacrylamide, N,N-dimethylmethacrylamide and N,N-diethylmethacrylamide; acrylamides such as acrylamide, N-methylacrylamide, N-ethylacrylamide, N-isopropylacrylamide, N,N-dimethylacrylamide and N,N-diethylacrylamide; carboxyl group-containing vinyl monomer such as methacrylic acid, acrylic acid, ctotonic acid, maleic acid, maleic anhydride and fumaric acid; aromatic vinyl monomers such as styrene, α-methylstyrene and p-methylstyrene; conjugated diene monomers such as butadiene and isoprene; olefins such as ethylene and propylene; and lactones such as ∈-caprolactone and valerolactone.

The polymer block (B1) constituting the multiblock copolymer is a polymer block comprising (meth)acrylic ester units and consisting of a polymer different in structure from the polymer block (A1). The (meth)acrylic ester unit is preferably a structural unit derived from an alkyl (meth)acrylate whose alkyl group may have a substituent and/or a cyclic alkyl (meth)acrylate whose cyclic alkyl group may have a substituent.

The content, in the polymer block (B1), of the structural unit derived from (meth)acrylic ester may be selected from structural units in the experimentally optimum range, depending on specific use, required performance, and other compounded components such as a light absorbing agent. In particular, the polymer block (B1) preferably contains a methacrylic ester structural unit in a ratio of 50 weight % or more, from the viewpoint of the effect of the present invention. The methacrylic ester unit is preferably a structural unit derived from an alkyl methacrylate whose alkyl group may have a substituent and/or a cyclic alkyl methacrylate whose cyclic alkyl group may have a substituent. Specific examples of the alkyl methacrylate and cyclic alkyl methacrylate include methyl methacrylate, ethyl methacrylate, isopropyl methacrylate, sec-butyl methacrylate, isobutyl methacrylate, tert-butyl methacrylate, cyclohexyl methacrylate, isobornyl methacrylate, 2-methoxyethyl methacrylate, 2-(N,N-dimethylamino)ethyl methacrylate, trifluoromethyl methacrylate, n-pentyl methacrylate, n-hexyl methacrylate, 2-ethylhexyl methacrylate, dodecyl methacrylate, tridecyl methacrylate, stearyl methacrylate, 2-methoxypentyl methacrylate, 2-(N,N-dimethylamino)pentyl methacrylate, perfluoropentyl methacrylate, and 2-trimethoxysilylpentyl methacrylate.

From the viewpoint of improvement of the durability of a light absorbing agent in the resulting adhesive layer, it is preferable that the polymer block (B1) is particularly a block consisting of a polymer containing, in a ratio of 50 weight % or more, a structural unit derived from an alkyl methacrylate having an alkyl group containing 1 to 4 carbon atoms, such as methyl methacrylate, ethyl methacrylate, isopropyl methacrylate, sec-butyl methacrylate, isobutyl methacrylate and tert-butyl methacrylate and a structural unit derived from an alkyl methacrylate having an alkyl group having a cyclic structure, such as cyclohexyl methacrylate and isobornyl methacrylate.

Particularly, the polymer block (B1) is preferably a block consisting of a polymer containing 50 weight % or more of a structural unit derived from methyl methacrylate, from the viewpoint of transparency and improvement of the durability of a light absorbing agent.

The polymer block (B1) preferably contains the methacrylic ester-derived structural unit (methacrylic ester unit) in a ratio of 50 weight % or more, more preferably 80 weight % or more, still more preferably 90 weight % or more, further more preferably 100 weight %, based on the weight of the polymer block (B1). When the ratio of the methacrylic ester unit in the polymer block (B1) is less than 50 weight %, the adhesion and impact resistance of the resulting adhesive layer tend to be deteriorated, and the object of the present invention may hardly be achieved.

Other monomer units which are contained preferably in a ratio of 50 weight % or less, preferably 20 weight % or less, more preferably 10 weight % or less, in the polymer block (B1) in the block copolymer (I) include, for example, structural units derived from monomers such as the above-mentioned acrylic esters; the above-mentioned methacrylamides; the above-mentioned acrylamides; the above-mentioned carboxyl group-containing vinyl monomers; the above-mentioned aromatic vinyl monomers; the above-mentioned conjugated diene monomers; the above-mentioned olefins; and the above-mentioned lactones.

If the block copolymer is a tetrablock or more block copolymer having one or more polymer blocks (C) in addition to one polymer block (A1) and two polymer blocks (B1) or in addition to two polymer blocks (A1) and one polymer block (B1), then the type and constituent of the polymer block (C) are not limited. As long as the tetrablock or more block structure can be formed, the polymer block (C) may be the same as, or different from, the polymer block (A1) and/or the polymer block (B1). When the block copolymer is a pentablock or more block copolymer having two or more polymer blocks (C), the polymer blocks (C) may be the same or different from one another.

The polymer block (C) may be for example a polymer block having structural units derived from one or more of the above-mentioned monomers such as methacrylic esters; acrylic esters; methacrylamides; acrylamides; aromatic vinyl monomers; conjugated diene monomers; olefins; and lactones.

In particular, the polymer block (C) is preferably a polymer block containing 50 weight % or more structural units derived from methacrylic esters, acrylic esters, or aromatic vinyl monomers, from the viewpoint of heat stability and ease in introduction of the polymer block (C) into the block copolymer, more preferably a polymer block containing 50 weight % or more structure units derived from methacrylic esters and/or acrylic esters, from the viewpoint of heat resistance and the like.

In the present invention, the multiblock copolymer is preferably a block copolymer having a weight average molecular weight (Mw) of 50,000 or more, more preferably a weight average molecular weight (Mw) of 60,000 or more, from the viewpoint of good balance between adhesiveness and film-forming property and hard deterioration of a light absorbing agent. From the viewpoint of fluidity, the weight average molecular weight (Mw) of the block copolymer is preferably 500,000 or less, more preferably 300,000 or less. From these viewpoints, the block copolymer used in the present invention is preferably a block copolymer having a weight average molecular weight (Mw) of 50,000 to 500,000, more preferably a block copolymer having a weight average molecular weight of 60,000 to 300,000.

It was revealed that even if the same light absorbing agent is used, the durability of the light absorbing agent is deteriorated when the weight average molecular weight (Mw) of the multiblock copolymer is less than that defined above and is lower or when the molecular weight distribution (Mw/Mn) is out of that defined below and is broader. This tendency was observed when the light absorbing agent is an organic dye such as a near-infrared light absorbing agent, particularly a diimmonium-based compound.

The molecular weight of the polymer block (A1) in the multiblock copolymer used in the present invention is not particularly limited, but from the viewpoint of good balance between the adhesiveness and impact resistance of the resulting adhesive layer, the weight average molecular weight (Mw) of the polymer block (A1) is preferably 10,000 to 500,000, more preferably 20,000 to 300,000.

The molecular weight of the polymer block (B1) in the multiblock copolymer used in the present invention is not particularly limited either, but from the viewpoint of good balance between the adhesiveness and impact resistance of the resulting adhesive layer, the weight average molecular weight (Mw) of the polymer block (B1) is preferably 1,000 to 50,000, more preferably 5,000 to 30,000.

When the multiblock copolymer used in the present invention is a tetrablock or more block copolymer having the polymer block (C) in addition to the polymer block (A1) and the polymer block (B1), the molecular weight of the polymer block (C) is not particularly limited, but for effectively exhibiting heat resistance and mechanical properties, the weight average molecular weight (Mw) of the polymer block (C) is preferably 1,000 to 50,000, more preferably 1,000 to 30,000.

The molecular weight distribution (Mw/Mn) represented by the ratio (Mw/Mn) of the weight average molecular weight (Mw) to number-average molecular weight (Mn) of the multiblock copolymer used in the present invention is required to be less than 1.5, preferably 1.4 or less, more preferably 1.3 or less, further more preferably 1.2 or less.

When the molecular weight distribution (Mw/Mn) of the multiblock copolymer used in the present invention is less than 1.5 and the molecular weight distribution is narrow, the adhesiveness, film-forming property and impact resistance of the resulting adhesive layer can be improved, and the deterioration of the light absorbing agent by highly reactive low-molecular-weight components etc. can be suppressed.

The weight average molecular weight (Mw) and the molecular weight distribution (Mw/Mn) in this specification are determined with polystyrene-equivalent molecular weight by GPC (gel permeation chromatography). For example, GPC unit “HLC-8020” manufactured by Tosoh Corporation is used as an apparatus; “TSKgel GMHXL”, “G4000HXL” and “G5000HXL” manufactured by Tosoh Corporation are connected in series as separation columns; and the sample can be measured with tetrahydrofuran as the eluent at a flow rate of 1.0 ml/min. at a column temperature of 40° C. with a differential refractive index (RI) detector.

The glass transition temperature of the polymer block (A1) in the block copolymer used in the present invention is preferably −40° C. to 50° C., more preferably −30° C. to 30° C., from the viewpoint of adhesiveness. The glass transition temperature of the polymer block (B1) in the block copolymer used in the present invention is preferably 80° C. to 140° C., more preferably 100° C. to 120° C., from the viewpoint of adhesiveness. Using a combination of the polymer blocks having such glass transition temperatures, the polymer block (A1) serves as a softer segment, and the polymer block (B1) serves as a harder segment, thereby easily forming a microphase-separated structure and easily improving film-forming property and impact resistance together with adhesiveness. Particularly when the block copolymer has the triblock structure (B1)-(A1)-(B1) wherein the glass transition temperature of the polymer block (A1) as determined by a differential scanning calorimeter is −40° C. to 50° C. and the glass transition temperature of the polymer block (B1) as determined by a differential scanning calorimeter is 100° C. to 120° C., a pseudo-crosslinked structure is easily formed by the polymer block (B1), thereby improving impact resistance together with adhesiveness.

The glass transition temperature of the multiblock copolymer used in the present invention is preferably −100° C. to 0° C., more preferably −50° C. to −5° C., from the viewpoint of adhesiveness.

The glass transition temperature in this specification is measured with a differential scanning calorimeter (for example, DSC204 Phoenix manufactured by NETZSCH) according to JIS K7121. The measurement method can be carried out for example at a measurement initiation temperature of −50° C., at a measurement termination temperature of 200° C., and at an increasing and decreasing temperature rate of 2° C./min., in a nitrogen atmosphere. As used herein, the glass transition temperature refers to the temperature (midpoint glass transition temperature) at which a line located at an equal distance in the ordinate direction from an extending line of each base line intersects with a curve of glass transition with stepwise change.

In the block copolymer used in the present invention, the content of the polymer block (B1) (or when two polymer blocks (B1) are contained, the total content thereof) is preferably 5 to 30 weight % (the content of the polymer block (A1) is 95 to 70 weight %), more preferably 5 to 22 weight %, even more preferably 5 to 20 weight %, based on the weight of the block copolymer, from the viewpoint of attaining an adhesive layer more excellent in adhesiveness and impact resistance.

The method for manufacturing the block copolymer used in the present invention is not particularly limited, and any methods may be used in so far as the multiblock copolymer having the properties described above and having a weight average molecular weight of 50,000 or more and the molecular weight distribution (Mw/Mn) of less than 1.5. The block copolymer having a narrow molecular weight distribution (Mw/Mn) of less than 1.5 used in the present invention can be produced easily by an anion polymerization method or an atom transfer radical polymerization method (ATRP), particularly an anion polymerization method.

From the point of view that a polymer having a narrower molecular weight distribution (Mw/Mn) can be produced, and the intended block copolymer can be purified with high purity, examples of the anion polymerization method include a method of anion polymerization with an organic alkali metal compound as a polymerization initiator in the presence of a mineral acid salt such as a salt with an alkali metal or an alkaline earth metal (see Japanese Patent Application Publication No. 7-25859), a method of anion polymerization with an organic alkali metal compound as a polymerization initiator in the presence of an organoaluminum compound (see JP-A No. 11-335432) and a method of anion polymerization with an organic rare earth metal complex as a polymerization initiator (see JP-A No. 6-93060).

When the anion polymerization is used, there is an advantage that a polymer having a narrower molecular weight distribution can be produced, residual monomers can be reduced, and the formed block copolymer has a highly syndiotactic molecular structure and a high glass transition temperature (Tg). From these viewpoints, the block copolymer used in the present invention is preferably a block copolymer obtained by anion polymerization. In particular, the block copolymer obtained by anion polymerization in the presence of an organoaluminum compound is preferably used because anion polymerization can be carried out at a relatively high temperature instead of very low temperature, thereby reducing the environmental burden (mainly the cost of a cold chamber machine for regulating the polymerization temperature) in producing the block copolymer.

When the block copolymer used in the present invention is produced by anion polymerization, it is possible to use a method wherein acrylic ester monomers or (meth)acrylic ester monomers for forming the respective polymer blocks in the block copolymer are successively polymerized for example in the presence of an organic lithium compound and a specific organoaluminum compound as described in JP-A No. 11-335432 etc., further using, if necessary, N,N,N′,N″,N″-pentamethyldiethylenetriamine or another tertiary amine, 1,2-dimethoxyethane, or an ether such as crown ether such as 12-crown-4 (see Patent Document 3).

The content of residual reactive substances and reactive low-molecular-weight components such as residual monomers and oligomers, which may be contained in the multiblock copolymer, varies depending on properties thereof and is not particularly limited, but is preferably for example 100 ppm by weight or less, more preferably 1 ppm by weight or less.

<Resin (II)>

The resin (II) is a component which suppresses deterioration of the light absorbing agent (III) even further at high temperature and high humidity by adding the resin (II) in the multiblock copolymer (I). Specifically, the resin (II) can make 0.015 or less both chromatic differences Δx and Δy of a film consisting of the adhesive composition, before and after left in an atmosphere at an ambient temperature of 80° C. and a relative humidity of 10% or less for 1,000 hours.

As the resin (II), it may be accordingly selected one which can attain the above-mentioned numeric values. However, it is preferable to use a component which can improve heat resistance properties of the adhesive layer and which can suppress migration of the light absorbing agent (III) in the adhesive layer by adding the resin (II) in the above-mentioned multiblock copolymer (I).

As the resin (II) which can attain the above-mentioned numeric values, it is preferable the resin is selected from the component not having adhesiveness. In addition, it is preferable the resin (II) is a component which does not provide a plastic property from the viewpoint of suppressing migration of light absorbing agent (III) and the weight average molecular weight of the component is 3,000 or more. In particular, the weight average molecular weight is preferably 500,000 or less, more preferably 200,000 or less, and further more preferably 50,000 or less, from the viewpoint of a compatibility with the block copolymer (I).

It is preferable that the resin (II) satisfies 5% or less of haze value in accordance with JIS K7105-1981 of a coating film with a thickness of 25 μm which is formed of a mixture mixed in a range from 3 to 50 parts by weight of the resin (II) used in the present invention with respect to 100 parts by weight of the multiblock copolymer (I). The transparency as the optical filter can be ensured by selecting the multiblock copolymer (I) and the resin (II) having a good compatibility therebetween.

An acid number of the resin (II) used in the present invention is preferably 30 or less, more preferably 10 or less, from the viewpoint of suppressing deterioration of the light absorbing agent.

The resin (II) used in the present invention is preferably one or more resins selected from the group consisting of an acrylic resin, an ester resin, an acrylic ester resin, a styrene resin, a polyvinyl resin and a polycarbonate resin from the viewpoint of ensuring transparency as the optical filter.

The amount of the block copolymer (I) and the resin (II) used in the present invention may be accordingly selected from the viewpoint of the transparency or the adhesiveness and may not be particularly limited. Generally, the resin (II) used in the present invention is preferably from 3 to 50 parts by weight, more preferably from 5 to 25 parts by weight, with respect to 100 parts by weight of the block copolymer (I) from the viewpoint of a balance between the adhesiveness and the transparency.

As the resin (II) used in the present invention, the resin (IV) having the glass transition temperature of 60° C. or more is suitably used.

<Resin (IV) Having the Glass Transition Temperature of 60° C. or More>

The resin (IV) having the glass transition temperature of 60° C. or more used in the present invention is a resin not having adhesiveness and a component having a function to suppress the plastic property by adding the resin (IV) to the above-mentioned multiblock copolymer (I). It is assumed that the resin (IV) having the glass transition temperature of 60° C. or more used in the present invention improves heat resistance properties when forming the adhesive layer with the above-mentioned multiblock copolymer (I) and suppresses a cohesion or a change in dispersion state by suppressing movement of the after-mentioned light absorbing agent (III) at high temperature.

An adhesive contains a component having low glass transition temperature and has usually a glass transition temperature of less than 0° C. as a whole from the viewpoint of the adhesiveness. It is preferable the above-mentioned multiblock copolymer (I) mainly contains the polymeric block (A1) having the glass transition temperature of −40° C. to 50° C. from the viewpoint of the adhesiveness. It is assumed that such an adhesive having a low glass transition temperature may easily fluidize molecules and increase a mobility of the light absorbing agent (III). Thereby, it is assumed that the light absorbing agent (III) can easily move at high temperature and a probability of coming into contact with a component which can deteriorate the light absorbing agent is increased (for example, it is assumed that the component is a polar functional group of polymeric monomer residue in a binder resin, a sodium ion from a glass when disposed adjacent to a glass plate or a metallic ion when disposed adjacent to an electromagnetic wave shielding layer containing metal), therefore the light absorbing agent (III) easily deteriorates.

In the present invention, it is assumed that by adding the resin (IV) having the glass transition temperature of 60° C. or more to the multiblock copolymer (I) which functions as the adhesive, a migration of the light absorbing agent can be suppressed in the adhesive layer and a probability of the light absorbing agent to agglutinate, to change a dispersing condition and to come into contact with deteriorated components decreases even at high temperature and high humidity so that a stability of the light absorbing agent is dramatically improved at high temperature and high humidity, thus an effect that hardly causes change in spectral characteristic attributed to a deterioration of light absorbing agents can be obtained.

The glass transition temperature of the resin (IV) used in the present invention is 60° C. or more, preferably 80° C. or more, from the viewpoint of suppression of deterioration of the light absorbing agent. The glass transition temperature of the resin (IV) having the glass transition temperature of 60° C. or more is preferably 200° C. or less from the viewpoint of adhesion.

As the resin (IV) having the glass transition temperature of 60° C. or more used in the present invention, a resin which transmits light of a visible light range is suitably used because of applying as a layer having the optical filter function used in the display device. Herein, the term “transmit light of a visible light range” includes the case that an average light transmittance in the visible light range from 380 to 780 nm is 50% or more, preferably 70% or more, more preferably 85% or more. The light transmittance is measured with the use of an ultraviolet-visible spectral photometer (for example, product name: UV-3100PC, manufactured by Shimadzu Corporation.) and the values which are measured at room temperature and in the air are used.

It is preferable the resin (IV) having the glass transition temperature of 60° C. or more used in the present invention has a high compatibility with the multiblock copolymer (I).

Specifically, it is preferable to select the resin (IV) in which haze value is 5% or less when a coating film with a thickness of 25 μm is formed by a mixture mixed in a range from 3 to 50 parts by weight of the resin (IV) having the glass transition temperature of 60° C. or more with respect to 100 parts by weight of the multiblock copolymer (I) and the haze value is measured in accordance with JIS K7105-1981. The haze value is more preferably 3% or less, particularly preferably 1% or less.

An acid number of the resin (IV) having the glass transition temperature of 60° C. or more used in the present invention is preferably 30 or less, more preferably 15 or less, and further more preferably 10 or less, from the viewpoint of suppressing a deterioration of the light absorbing agent. The acid number herein is “mg” number of potassium hydroxide which is required to neutralize free fatty acid, resin acid or the like which is contained in a sample of 1 g, which can be measured by a method in accordance with JIS K0070-1992.

As the resin (IV) having the glass transition temperature of 60° C. or more, one or more resins selected from the group consisting of an acrylic resin, an ester resin, an acrylic ester resin, a styrene resin, a polyvinyl resin and a polycarbonate resin having an average light transmittance in the visible light range from 380 to 780 nm of 50% or more are preferable from the viewpoint of ensuring the transparency of the optical filter. Among them, one or more resins selected from the group consisting of an acrylic resin having a repeating unit which is derived from an acrylic acid derivative are preferable from the viewpoint of compatibility with the multiblock copolymer (I) and transparency.

It is preferable the resin (IV) having the glass transition temperature of 60° C. or more is a resin having a (meth)acrylic ester unit which forms a block structure of the multiblock copolymer (I) from the viewpoint of ensuring the transparency as the optical filter. As the (meth)acrylic ester unit, the same repeating unit as mentioned in the multiblock copolymer (I) can be used. In particular, it is preferable the (meth)acrylic ester unit contains a structural unit derived from (meth)acrylic alkyl ester which may have a substituent in an alkyl group and/or (meth)acrylic cyclic alkyl ester which may have a substituent in a cyclic alkyl group. As specific examples, there may be the same repeating units as mentioned in the multiblock copolymer (I).

In particular, it is preferable the resin (IV) having the glass transition temperature of 60° C. or more is a resin having a methacrylic acid alkyl ester unit from the viewpoint of the compatibility with the multiblock copolymer (I). Among them, a resin having a methyl methacrylate unit is particularly preferred.

When using the resin having a (meth)acrylic ester unit as the resin (IV) having the glass transition temperature of 60° C. or more used in the present invention, the resin may contain monomer units other than the same units as mentioned in the multiblock copolymer (I). However, it is preferable the resin does not substantially contain a carboxyl group and an amide group from the viewpoint of suppressing the deterioration of the light absorbing agent by the resin (IV) having the glass transition temperature of 60° C. or more. Herein, the term “not substantially contain” refers that the resin having the (meth)acrylic ester unit does not intentionally incorporate the carboxyl group and the amide group by, for example, copolymerization or the like. The term “not substantially contain a carboxyl group and an amide group” includes even the case that, for example, the resin having the (meth)acrylic ester unit contains a little amount of the carboxyl group and the amide group as a result due to hydrolysis of a part of resin having an acrylic ester monomer or a (meth)acrylic ester unit during the polymerization reaction or in the process of storage or transport of an obtained copolymer if the amount of the carboxyl group or amide group is an amount that deterioration of light absorbing agent is practically ignorable.

From the above viewpoints, as the resin (IV) having the glass transition temperature of 60° C. or more, preferred examples include polymethylmethacrylate, poly isobornylmethacrylate, polytert-butylmethacrylate, polycyclohexylmethacrylate and copolymers containing thereof.

As the resin (IV) having the glass transition temperature of 60° C. or more used in the present invention, it is preferable the resin has solubility in a good solvent of the light absorbing agent (III) to be used. Herein, “solubility” means, specifically, the resin (IV) can be dissolved in a good solvent of the light absorbing agent (III) at 25° C. in a concentration of 5% by weight or more, preferably 10% by weight or more. In addition, the good solvent of the light absorbing agent (III) means, specifically, a solvent which can dissolve the light absorbing agent (III) at 25° C. in a concentration of 0.01% by weight or more, preferably 0.05% by weight or more.

Depending on the selected light absorbing agent (III), the light absorbing agent (III) may hardly dissolve in a good solvent of the block copolymer (I). In this case, it is considered that the light absorbing agent (III) does not well disperse in the block copolymer (I) and easily moves in the layer so that the light absorbing agent (III) agglutinates or its dispersion state easily changes, which leads to easy deterioration of the light absorbing agent (III). To the contrary, in the case that the resin (IV) having the glass transition temperature of 60° C. or more has good solubility in the good solvent of the light absorbing agent (III), a mixed solution of the selected light absorbing agent (III) and the resin (IV) having the glass transition temperature of 60° C. or more can be prepared in advance. In this case, it is considered that the light absorbing agent (III) is well dispersed in the resin (IV) having the glass transition temperature of 60° C. or more and the resin (IV) having the glass transition temperature of 60° C. or more has high heat resistance so that the light absorbing agent (III) hardly moves even at high temperature and hardly agglutinates, thus deterioration of the light absorbing agent (III) hardly occurs.

The weight average molecular weight of the resin (IV) having the glass transition temperature of 60° C. or more used in the present invention is preferably 500,000 or less, more preferably 200,000 or less, and further more preferably 50,000 or less, from the viewpoint of improving the compatibility with the block copolymer (I) and increasing the transparency. On the other hand, the weight average molecular weight is preferably 3,000 or more, and more preferably 5,000 or more, from the viewpoint of decreasing change in spectral characteristics of the light absorbing agent at high temperature and high humidity.

The amounts of the block copolymer (I) and the resin (IV) having the glass transition temperature of 60° C. or more used in the present invention may be accordingly selected from the viewpoint of the transparency or adhesiveness and may not be particularly limited. Generally, the resin (IV) having the glass transition temperature of 60° C. or more used in the present invention is preferably from 3 to 50 parts by weight, more preferably from 5 to 25 parts by weight, with respect to 100 parts by weight of the block copolymer (I) from the viewpoint of a balance between adhesiveness and transparency.

### <Light Absorbing Agent (III)>

A light absorbing agent each having light absorption in a predetermined wavelength range used in the present invention is used for the purpose of removing unnecessary emission component which is emitted from a display device and enhancing display colors. A light absorbing agent having an absorption band region in desired wavelength range may be appropriately used for purpose. A dye which acts as the light absorbing agent is also suitably used. Specifically, there may be a light absorbing agent having an absorption band region at least in the wavelength from 800 to 1,100 nm (hereinafter, this light absorbing agent is specifically referred to as “near-infrared light absorbing agent”), a light absorbing agent for the purpose of obtaining a neon light absorption having an absorption band region at least in the wavelength from 570 to 610 nm (hereinafter, this light absorbing agent is specifically referred to as “neon light absorbing agent”), a light absorbing agent (dye) for the purpose of adjusting color tone having an absorption band region at least in the wavelength from 380 to 570 nm or from 610 to 780 nm (hereinafter, this light absorbing agent is specifically referred to as “color correction dye”) and so on. These light absorbing agents may be used alone or in combination of two or more. As other light absorbing agents as mentioned below, a light absorbing agent having an absorption band region in the wavelength of 380 nm or less (hereinafter, this light absorbing agent is specifically referred to as “UV absorbing agent”) may be added if necessary.

### <Near-Infrared Light Absorbing Agent>

The near-infrared light absorbing agent can be selected from arbitrary compounds capable of absorbing light in the wavelength range of 800 to 1,100 nm. Among them, preferable is the near-infrared light absorbing agent which absorbs light in the wavelength range of 800 to 1,100 nm and less absorbs the wavelength in the visible light region, that is, the wavelength range from 380 to 780 nm, so as to have enough light transmittance.

As the near-infrared light absorbing agent having the maximum absorption wavelength at least within the wavelength range from 800 to 1,100 nm, specific examples include an organic near-infrared light absorbing agent such as a polymethine-based compound, a cyanine-based compound, a phthalocyanine-based compound, a naphthalocyanine-based compound, a naphthoquinone-based compound, an anthraquinone-based compound, a dithiol-based compound, an immonium-based compound, a diimmonium-based compound, an aminium-based compound, a pyrylium-based compound, a serylium-based compound, a squarylium-based compound, a copper complex, a nickel complex, a dithiol-based metal complex or the like; or an inorganic near-infrared light absorbing agent such as tin oxide, indium oxide, magnesium oxide, titanium oxide, chromium oxide, zirconium oxide, nickel oxide, aluminum oxide, zinc oxide, iron oxide, ammonium oxide, lead oxide, bismuth oxide, lanthanum oxide, tungsten hexachloride, a composite tungsten oxide particle or the like. One or more kinds thereof can be used. In particular, an adequate effect of the present invention is provided in the case of the organic near-infrared light absorbing agent, which can easily deteriorate spectral characteristic by specific functional group in the adhesive.

Herein, the term “based compound” means a group of derivatives. For example, in the case of the anthraquinone-based compound, it means an anthraquinone derivative. Among the above, the anthraquinone base compound, the naphthoquinone base compound, the phthalocyanine-based compound and the diimmonium-based compound are preferable. Among them, the phthalocyanine-based compound and/or the diimmonium-based compound is preferable from the viewpoint of high transmittance in the visible region.

The diimmonium-based compound is preferable from the viewpoint of a large absorption in the near-infrared region, particularly in the wavelength range from 900 to 1,100 nm, a wide absorption range and a high transmittance in the visible region. Also, the phthalocyanine-based compound is preferable from the viewpoint of further expanding an absorption range of near-infrared region when used in combination with the diimmonium-based compound since the phthalocyanine-based compound has an absorption range is from 800 to 1,000 nm and has a relatively high durability. It is particularly preferable to use both the phthalocyanine-based compound and the diimmonium-based compound as the above-mentioned advantage can be obtained.

The organic dye, particularly the diimmonium-based compound, originally having a predominant tendency to deteriorate in an adhesive layer having the near-infrared light absorbing agent added can be suitably used since the deterioration can be suppressed even under high temperature and high humidity by using a combination of the above-specified acrylic copolymer (A) and isocyanine compound (B) in the present invention.

As the diimmonium-based compound, a diimmonium-based compound represented by the following Formula (1) can be specifically exemplified:

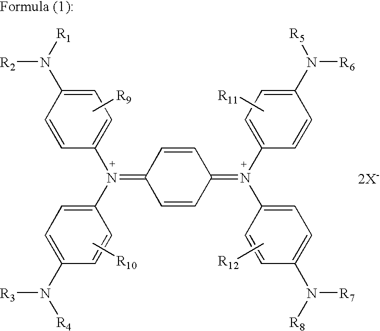

wherein, each of R₁ to R₈ is a hydrogen atom, an alkyl group, an aryl group, an alkenyl group, an aralkyl group or an alkynyl group, which may be the same or different from each other; each of R₉ to R₁₂ is a hydrogen atom, a halogen atom, an amino group, a cyano group, a nitro group, a carboxyl group, an alkyl group or an alkoxy group, which may be the same or different from each other; any of R₁ to R₁₂ which can be bonded with a substituent may have a substituent; and X⁻ is an anion.

Specific examples of each of R₁ to R₈ in the Formula (1) include optionally substituted alkyl groups such as a methyl group, an ethyl group, a n-propyl group, an iso-propyl group, a n-butyl group, an iso-butyl group, a tert-butyl group, a n-amyl group, a n-hexyl group, a n-octyl group, a 2-hydroxyethyl group, a 2-cyanoethyl group, a 3-hydroxypropyl group, a 3-cyanopropyl group, a methoxyethyl group, an ethoxyethyl group, and a butoxyethyl group. Also, optionally substituted aryl groups include a phenyl group, a fluorophenyl group, a chlorophenyl group, a tolyl group, a diethylaminophenyl group, and a naphthyl group. Also, optionally substituted alkenyl groups include a vinyl group, a propenyl group, a butenyl group, and a pentenyl group. Also, optionally substituted aralkyl groups include a benzyl group, a p-fluorobenzyl group, a p-chlorophenyl group, a phenylpropyl group, and a naphthylethyl group. Among them, a branched chain alkyl group such as the iso-propyl group, the iso-butyl group, and the tert-butyl group is preferable from the viewpoint of increasing point of pyrolysis of the diimmonium-based compound and improving durability. It is preferable at least one of R₁ to R₈ is a branched chain alkyl group. It is more preferable all of R₁ to R₈ are branched chain alkyl groups.

Examples of R₉ to R₁₂ include hydrogen, fluorine, chlorine, bromine, a diethyl amino group, a dimethylamino group, a cyano group, a nitro group, a methyl group, an ethyl group, a propyl group, a trifluoromethyl group, a methoxy group, an ethoxy group, and a propoxy group.

“X⁻” as an inorganic monovalent anion includes, for example, a halogen ion such as a fluorine ion, a chlorine ion, a bromine ion and an iodine ion, a thiocyanate ion, a hexafluoroantimonate ion, a perchlorate ion, a periodate ion, a nitrate ion, a tetrafluoroborate ion, a hexafluorophosphate ion, a molybdate ion, a tungstate ion, a titanate ion, a vanadate ion, a phosphate ion, and a borate ion. “X⁻” as an organic acid monovalent anion includes, for example, an organic carboxylate ion such as an acetate ion, a lactate ion, a trifluoroacetate ion, a propionate ion, a benzoate ion, an oxalate ion, a succinate ion and a stearate ion; an organic sulfonate ion such as a methanesulfonate ion, a toluene sulfonate ion, a naphthalene monosulfonate ion, a chlorobenzene sulfonate ion, a nitrobenzene sulfonate ion, a dodecyl benzene sulfonate ion, a benzene sulfonate ion, an ethane sulfonate ion and a trifluoromethane sulfonate ion; and an organic borate ion such as a tetraphenyl borate ion and a butyltriphenyl borate ion. Further, a sulfonyl imidate ion includes a bischloromethanesulfonyl imidate ion, a bisdichloromethanesulfonyl imidate ion, a bistrichloromethanesulfonyl imidate ion, a bisfluorosulfonyl imidate ion, a bisdifluoromethanesulfonyl imidate ion, a bistrifluoromethanesulfonyl imidate ion, and a bispentafluoroethanesulfonyl imidate ion. In particular, the sulfonyl imidate ion is preferable from the viewpoint of improving durability as a result of stabilizing the diimmonium compound, which is an ionizable compound, by strong electronic attractivity. The bistrifluoromethanesulfonyl imidate ion is particularly preferable thereamong. However, the present invention may not be limited to the above.

A part of the diimmonium compound is commercially available. For example, Kayasorb IRG-022, IRG-068 (product name, manufactured by: NIPPON KAYAKU CO., LTD.) or the like may be suitably used.

As the phthalocyanine-based compound, a phthalocyanine-based compound represented by the following Formula (2) can be specifically exemplified:

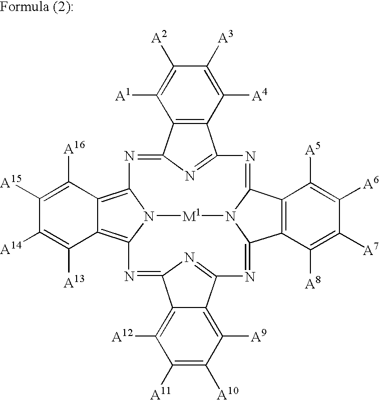

wherein, each of A¹ to A¹⁶ is independently a hydrogen atom, a halogen atom, a hydroxyl group, an amino group, a hydroxylsulfonyl group, an aminosulfonyl group, a substituent having 1 to 20 carbons which may contain a nitrogen atom, a sulfur atom, an oxygen atom or a halogen atom, in which two adjacent substituents may be bonded via linking group; M¹ is vanadium oxide or copper.

In the present invention, among the above phthalocyanine-based compounds, it is preferable to use at least three kinds of phthalocyanine-based compounds out of the following four kinds of phthalocyanine-based compounds (A) to (D).

Phthalocyanine-based compound (A): a phthalocyanine-based compound represented by the Formula (2), wherein each of at least four out of A¹ to A¹⁶ is a substituent via a sulfur atom and each of at least three out of A¹ to A¹⁶ contains a chlorine atom; and M¹ is vanadium oxide.

Phthalocyanine-based compound (B): a phthalocyanine-based compound represented by the Formula (2), wherein each of at least four out of A¹ to A¹⁶ is a substituent via a sulfur atom and does not substantially contain a chlorine atom; and M¹ is vanadium oxide.

Phthalocyanine-based compound (C): a phthalocyanine-based compound represented by the Formula (2), wherein each of at least four out of A¹ to A¹⁶ is a substituent via a nitrogen atom and does not substantially contain a substituent via a sulfur atom; and M¹ is vanadium oxide.

Phthalocyanine-based compound (D): a phthalocyanine-based compound represented by the Formula (2), wherein each of at least four out of A¹ to A¹⁶ is a substituent via a nitrogen atom and does not substantially contain a substituent via a sulfur atom; and M¹ is copper.

In the Formula (2), the halogen atom includes a fluorine atom, a chorine atom, a bromine atom, an iodine atom or the like. The fluorine atom and the chorine atom are particularly preferable thereamong.

In the Formula (2), as the substituent having 1 to 20 carbons which may contain a nitrogen atom, a sulfur atom, an oxygen atom or a halogen atom, there may be a linear, branched or cyclic alkyl group such as a methyl group, an ethyl group, a n-propyl group, an iso-propyl group, a n-butyl group, an iso-butyl group, a sec-butyl group, a t-butyl group, a n-pentyl group, a n-hexyl group, a cyclohexyl group, a n-heptyl group, a n-octyl group, and a 2-ethylhexyl group; an alkyl group containing a hetero atom or an aromatic ring such as a methoxymethyl group, a phenoxymethyl group, a diethylaminomethyl group, a phenylthiomethyl group, a benzyl group, a p-chlorobenzyl group, and a p-methoxybenzyl group; an aryl group such as a phenyl group, a p-methoxyphenyl group, a p-t-butylphenyl group, and a p-chlorophenyl group; an alkoxy group such as a methoxy group, an ethoxy group, a n-propyloxy group, an iso-propyloxy group, a n-butyloxy group, an iso-butyloxy group, a sec-butyloxy group, a t-butyloxy group, a n-pentyloxy group, a n-hexyloxy group, a cyclohexyloxy group, a n-heptyloxy group, a n-octyloxy group, and a 2-ethylhexyloxy group; an alkoxyalkoxy group such as a methoxyethoxy group, and a phenoxyethoxy group; a hydroxylalkoxy group such as a hydroxylethoxy group; an aralkyloxy group such as a benzyloxy group, a p-chlorobenzyloxy group, and a p-methoxybenzyloxy group; an aryloxy group such as a phenoxy group, a p-methoxyphenoxy group, a p-t-butylphenoxy group, a p-chlorophenoxy group, an o-aminophenoxy group, and a p-diethylaminophenoxy group; an alkylcarbonyloxy group such as an acetyloxy group, an ethylcarbonyloxy group, a n-propylcarbonyloxy group, an iso-propylcarbonyloxy group, a n-butylcarbonyloxy group, an iso-butylcarbonyloxy group, a sec-butylcarbonyloxy group, a t-butylcarbonyloxy group, a n-pentylcarbonyloxy group, a n-hexylcarbonyloxy group, a cyclohexylcarbonyloxy group, a n-heptylcarbonyloxy group, a 3-heptylcarbonyloxy group, and a n-octylcarbonyloxy group; an arylcarbonyloxy group such as a benzoyloxy group, a p-chlorobenzoyloxy group, a p-methoxybenzoyloxy group, a p-ethoxybenzoyloxy group, a p-t-butylbenzoyloxy group, a p-trifluoromethylbenzoyloxy group, a m-trifluoromethylbenzoyloxy group, an o-aminobenzoyloxy group, and a p-diethylaminobenzoyloxy group; an alkylthio group such as a methylthio group, an ethylthio group, a n-propylthio group, an iso-propylthio group, a n-butylthio group, an iso-butylthio group, a sec-butylthio group, a t-butylthio group, a n-pentylthio group, a n-hexylthio group, a cyclohexylthio group, a n-heptylthio group, a n-octylthio group, and a 2-ethylhexylthio group; an aralkylthio group such as a benzylthio group, a p-chlorobenzylthio group, and a p-methoxybenzylthio group; an arylthio group such as a phenylthio group, a p-methoxyphenylthio group, a p-t-butylphenylthio group, a p-chlorophenylthio group, an o-aminophenylthio group, an o-(n-octylamino)phenylthio group, an o-(benzilamino)phenylthio group, an o-(methylamino)phenylthio group, a p-diethylaminophenylthio group, and a naphthylthio group; an alkylamino group such as a methylamino group, an ethylamino group, a n-propylamino group, a n-butylamino group, a sec-butylamino group, a n-pentylamino group, a n-hexylamino group, a n-heptylamino group, a n-octylamino group, a 2-ethylhexylamino group, a dimethylamino group, a diethylamino group, a di-n-propylamino group, a di-n-butylamino group, a di-sec-butylamino group, a di-n-pentylamino group, a di-n-hexylamino group, a di-n-heptylamino group, and a di-n-octylamino group; an arylamino group such as a phenylamino group, a p-methylphenylamino group, a p-t-butylphenylamino group, a diphenylamino group, a di-p-methylphenylamino group, and a di-p-t-butylphenylamino group; an alkylcarbonylamino group such as an acetylamino group, an ethylcarbonylamino group, a n-propylcarbonylamino group, an iso-propylcarbonylamino group, a n-butylcarbonylamino group, an iso-butylcarbonylamino group, a sec-butylcarbonylamino group, a t-butylcarbonylamino group, a n-pentylcarbonylamino group, a n-hexylcarbonylamino group, a cyclohexylcarbonylamino group, a n-heptylcarbonylamino group, a 3-heptylcarbonylamino group, and a n-octylcarbonylamino group; an arylcarbonylamino group such as a benzoylamino group, a p-chlorobenzoylamino group, a p-methoxybenzoylamino group, a p-methoxybenzoylamino group, a p-t-butylbenzoylamino group, a p-chlorobenzoylamino group, a p-trifluoromethylbenzoylamino group, and a m-trifluoromethylbenzoylamino group; an alkoxycarbonyl group such as a hydroxycarbonyl group, a methoxycarbonyl group, an ethoxycarbonyl group, a n-propyloxycarbonyl group, an iso-propyloxycarbonyl group, a n-butyloxycarbonyl group, an iso-butyloxycarbonyl group, a sec-butyloxycarbonyl group, a t-butyloxycarbonyl group, a n-pentyloxycarbonyl group, a n-hexyloxycarbonyl group, a cyclohexyloxycarbonyl group, a n-heptyloxycarbonyl group, a n-octyloxycarbonyl group, and a 2-ethylhexyloxycarbonyl group; an alkoxyalkoxycarbonyl group such as a methoxyethoxycarbonyl group, a phenoxyethoxycarbonyl group, and a hydroxyethoxycarbonyl group; an aryloxycarbonyl group such as a benzyloxycarbonyl group, a phenoxycarbonyl group, a p-methoxyphenoxycarbonyl group, a p-t-butylphenoxycarbonyl group, a p-chlorophenoxycarbonyl group, an o-aminophenoxycarbonyl group, and a p-diethylaminophenoxycarbonyl group; an alkylaminocarbonyl group such as an aminocarbonyl group, a methylaminocarbonyl group, an ethylaminocarbonyl group, a n-propylaminocarbonyl group, a n-butylaminocarbonyl group, a sec-butylaminocarbonyl group, a n-pentylaminocarbonyl group, a n-hexylaminocarbonyl group, a n-heptylaminocarbonyl group, a n-octylaminocarbonyl group, a 2-ethylhexylaminocarbonyl group, a dimethylaminocarbonyl group, a diethylaminocarbonyl group, a di-n-propylaminocarbonyl group, a di-n-butylaminocarbonyl group, a di-sec-butylaminocarbonyl group, a di-n-pentylaminocarbonyl group, a di-n-hexylaminocarbonyl group, a di-n-heptylaminocarbonyl group, and a di-n-octylaminocarbonyl group; an arylaminocarbonyl group such as a phenylaminocarbonyl group, a p-methylphenylaminocarbonyl group, a p-t-butylphenylaminocarbonyl group, a diphenylaminocarbonyl group, a di-p-methylphenylaminocarbonyl group, and a di-p-t-butylphenylaminocarbonyl group; an alkylaminosulfonyl group such as a methylaminosulfonyl group, an ethylaminosulfonyl group, a n-propylaminosulfonyl group, a n-butylaminosulfonyl group, a sec-butylaminosulfonyl group, a n-pentylaminosulfonyl group, a n-hexylaminosulfonyl group, a n-heptylaminosulfonyl group, a n-octylaminosulfonyl group, a 2-ethylhexylaminosulfonyl group, a dimethylaminosulfonyl group, a diethylaminosulfonyl group, a di-n-propylaminosulfonyl group, a di-n-butylaminosulfonyl group, a di-sec-butylaminosulfonyl group, a di-n-pentylaminosulfonyl group, a di-n-hexylaminosulfonyl group, a di-n-heptylaminosulfonyl group, and a di-n-octylaminosulfonyl group; or an arylaminosulfonyl group such as a phenylaminosulfonyl group, a p-methylphenylaminosulfonyl group, a p-t-butylphenylaminosulfonyl group, a diphenylaminosulfonyl group, a di-p-methylphenylaminosulfonyl group, and a di-p-t-butylphenylaminosulfonyl group.

As the adjacent two substituents which may be bonded via a linking group, there may be substituents which form a five-membered or six-membered ring via a hetero atom represented by the following formula or the like.

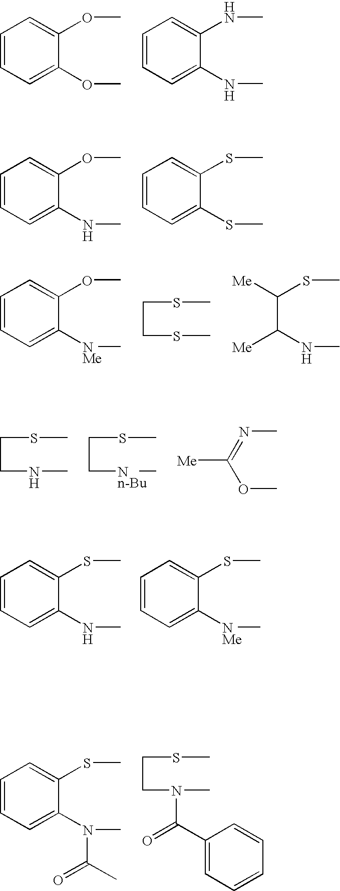

The “substituent via a sulfur atom” in the phthalocyanine-based compounds (A) and (B) or the “substituent via a nitrogen atom” in the phthalocyanine-based compounds (C) and (D) include an amino group, an aminosulfonyl group, an alkylthio group, an arylthio group, an alkylamino group, an arylamino group, an alkylcarbonylamino group, an arylcarbonylamino group or the like. An absorption wavelength of the phthalocyanine is normally in the range of around 600 to 750 nm, however, the absorption wavelength can become larger and can be 800 nm or more by introducing the substituent via a sulfur atom or a nitrogen atom. Therefore, at least four out of A¹ to A¹⁶ are substituents via sulfur atoms and/or nitrogen atoms. More preferably, eight or more out of A¹ to A¹⁶ are substituents via sulfur atoms and/or nitrogen atoms.

A combination of three or more kinds out of the above-mentioned four kinds of phthalocyanine-based compounds (A) to (D), a blend ratio of each phthalocyanine-based compound and so on are appropriately determined by an optical property (for example, absorption wavelength region, light transmittance or the like) corresponding to specific usage, purpose or the like of an optical filter. Three or more kinds out of the above-mentioned four kinds of phthalocyanine-based compounds (A) to (D) are selected to be able to absorb wavelengths in whole wavelength range of 800 nm to 1,100 nm by using compounds having different absorption wavelength regions in combination. For example, by using three kinds of compounds such as a phthalocyanine-based compound having an absorption band of 800 nm to 850 nm, a phthalocyanine-based compound having an absorption band region of 850 nm to 920 nm and a phthalocyanine-based compound having an absorption band region of 920 nm to 1,000 nm in combination, the wavelengths in whole wavelength range of 800 nm to 1,000 nm can be consecutively absorbed. Also, two or more kinds of compounds which are classified as the same kind of the phthalocyanine-based compound may be used.

The near-infrared light absorbing agent can be used alone or in combination of two or more kinds. A type or amount of near-infrared light absorbing agent may be appropriately selected in accordance with an absorption wavelength or absorption coefficient of the near-infrared light absorbing agent, color tone, required transmittance and so on. For example, the amount of the near-infrared light absorbing agent to be added may be about 0.001 to 15% by weight in an adhesive layer formed of a solid content of the adhesive composition.

The neon light absorbing agent can be selected from arbitrary compounds capable of absorbing light in a wavelength range of 570 to 610 nm. The neon light absorbing agent which absorbs light in the wavelength range of 570 to 610 nm (Ne light region) and less absorbs in the visible light region of 380 nm to 780 nm other than the above-mentioned wavelength range so as to have enough light transmittance is preferable.

The neon light absorbing agent includes a dye which is conventionally used as a dye having an absorption band region at least in the wavelength range of 570 to 610 nm, for example, cyanine-based, oxonol-based, methine-based, and subphthalocyanine-based, dyes or porphyrin-based, dyes such as tetraazaporphyrin. Among them, the tetraazaporphyrin is particularly preferable from the viewpoint of the durability under environmental conditions, a compatibility with an absorption property of the neon light region and a transparency of visible light of other wavelengths and so on.

The neon light absorbing agent can be used alone or in combination of two or more kinds. A type or an additive amount of the near-infrared light absorbing agent may be appropriately selected in accordance with an absorption wavelength or absorption coefficient of the neon light absorbing agent, color tone, required transmittance and so on. For example, the amount of the neon light absorbing agent to be added may be about 0.001 to 15 weight % in an adhesive layer.

### [Color Correction Dye]

A color correction dye is a dye for compensating a displayed image to preferable tone (natural tone, or a color which slightly transformed from natural color). As such a color correction dye, an organic dye, an inorganic dye or the like can be used alone or in combination of two or more.

As conventionally known dyes which can be used as the color correction dye, the dyes disclosed in JP-A No. 2000-275432, JP-A No. 2001-188121, JP-A No. 2001-350013, JP-A No. 2002-131530 and the like are suitably used. Other examples of usable dyes include dyes absorbing visible light such as yellow light, red light and blue light, for example dyes based on anthraquinone, naphthalene, azo, phthalocyanine, pyromethene, tetraazaporphyrin, squarylium and cyanine.

A type or an additive amount of color correction dye may be appropriately selected in accordance with an absorption wavelength or absorption coefficient of the color correction dye, color tone, required transmittance and so on. For example, the amount of color correction dye to be added may be about 0.001 to 15 weight % in the adhesive layer.

The adhesive composition in the present invention may include a light absorbing agent which is used for the purpose of removing unnecessary emission component from a display device and making display colors clear and also a UV absorbing agent to prevent the light absorbing agent from deterioration due to UV in outside light. The UV absorbing agent includes a compound having an absorbing spectrum in the ultraviolet light region of the wavelength of 380 nm or less, for example, an organic UV absorbing agent including a benzotriazole-based agent such as 2-(2′-hydroxy-5′-methylphenyl)benzotriazole; a benzophenone-based agent such as 2,4-dihydroxybenzophenone; a salicylate-based agent such as phenylsalicylate; a benzoate-based agent such as hexadecyl-2,5-t-butyl-4-hydroxybenzoate, and an inorganic UV absorbing agent such as titanium oxide, zinc oxide, cerium oxide, iron oxide, and barium sulfate.

### <Other Components>

The adhesive composition according to the present invention may further contain one or more kinds of an accelerator, a tackifier, a plasticizer, an antioxidant, filler, a silane coupling agent and so on unless the effect of the present invention is impaired.

In the adhesive composition in the present invention, a crosslinking agent such as an isocyanate compound may be contained insofar as the effect of the present invention is not impaired. However, the tackifier or the plasticizer works to accelerate a move of light absorbing agent (III) for its purpose of increasing adhesiveness and plastic property of the adhesive layer, thus, it is preferable not to contain the tackifier or the plasticizer from the viewpoint of suppressing change in spectral characteristics.

The tackifier includes, for example, a rosin derivative such as rosin ester, gum rosin, tall oil rosin, hydrogenated rosin ester, maleinated rosin, disproportionation rosin ester or the like; a terpene-based resin based on a terpene phenol resin or the like; a (hydrogenated) petroleum resin, a coumarone-indene-based resin, a hydrogenated aromatic copolymer, a styrene-based resin, a phenol-based resin, a xylene-based resin or the like. As the plasticizer, for example, an oligo acrylate-based plasticizer can be exemplified. In addition, as the antioxidant, a benzotriazole-based compound or the like can be exemplified. The benzotriazole-based compound, when used in a place in direct contact with the electroconductive mesh layer, is preferable for preventing the electroconductive mesh layer from being oxidized and discolored.

The adhesive composition according to the present invention may contain a solvent for dissolving or dispersing the above-mentioned respective components. As the solvent, one or more kinds may be accordingly selected and may not be particularly limited if the solvents can uniformly dissolve or disperse the block copolymer (I), the resin (II) or the resin (IV) having the glass transition temperature of 60° C. or more and a light absorbing agent (III), which are essential components of the present invention. Specifically, for example, the solvent includes, but is not limited to, toluene, methyl ethyl ketone, methyl isobutyl ketone and ethyl acetate.

The adhesive composition of the present invention can be obtained by, for example, mixing essential components, desired components and solvents if necessary in any order, followed by appropriate dispersion, if necessary.

In the case that no solvent exists for dissolving all the essential components such as the block copolymer (I), the resin (IV) having the glass transition temperature of 60° C. or more and the light absorbing agent (III) in good condition, the composition may be prepared in such a manner that, for example, the resin (IV) having the glass transition temperature of 60° C. or more and the light absorbing agent (III) are respectively or simultaneously dissolved in a common good solvent to prepare a solution, separately, the block copolymer (I) of the essential component is dissolved in a good solution of the copolymer (I) to prepare a solution, and the above-mentioned solutions are mixed. Alternatively, the composition may be prepared by dissolving each of the block copolymer (I), the resin (IV) having the glass transition temperature of 60° C. or more and the light absorbing agent (III) is dissolved in good solvent thereof to prepare solutions and mixing the solutions. In order to prepare a uniform composition, as the solvents which are used for each solution in which the above-mentioned each component is dissolved, it is preferable to select solvents which can be mixed uniformly. It is preferable to use a common solvent or a mixed solvent containing a common solvent.

II. Optical Filter

An optical filter according to the present invention is an optical filter to be disposed on the front face of a display device and comprises an adhesive layer having optical filter functions formed by the use of the adhesive composition for optical filter according to the present invention.

The optical filter of the present invention contains an adhesive layer having both adhesiveness and a desired optical filter function with a single layer formed with the use of the adhesive composition according to the present invention. Thereby, a production process of the optical filter of the present invention can be simplified and cost of the process can be reduced. In addition, change in spectral characteristic attributable to deterioration of light absorbing agent after long-term use, particularly at high temperature and high humidity, is hardly caused, thus a stability of spectral characteristic is excellent. Compared to a conventional optical filter directly attached to a display surface of a plasma display panel, the optical filter of the present invention can simplify a layer structure, reduce its weight and thickness of layer, thus, the production process can be simplified and the production cost thereof can be reduced.

The optical filter of the present invention may be comprised of only an adhesive layer having optical filter functions or the adhesive layer and a transparent substrate.

It is preferable that the optical filter of the present invention is in a form of a composite filter that one or more functional layers having one or more functions selected from the group consisting of electromagnetic wave shielding function, antireflection function, antiglare function, light absorption function and surface protection function are laminated on the adhesive layer having optical filter functions.

In the case that the optical filter of the present invention is the composite filter, the optical filter has an optical filter function which hardly causes change in spectral characteristic attributable to deterioration of light absorbing agent after long-term use, particularly at high temperature and high humidity and thus has an excellent stability of spectral characteristic, and further has a function of laminated functional layer, while having good adhesiveness. In the case that the optical filter of the present invention is the composite filter, the adhesive layer, which is always used when attaching functional layers or functional layer with a glass plate on the front of display device or with a glass substrate of the filter, has also the optical filter function. Therefore, the optical filter of the present invention can simplify a layer structure, reduce its weight and reduce thickness of layer, and the production process can be simplified and the production cost thereof can be reduced compared to a conventional composite filter.

In the optical filter according to the present invention, as long as the adhesive layer having optical filter functions is disposed on the front face of a display device, it may be used as a direct attachment to a glass plate disposed on the front face of a display device or for adhesive layers disposed between functional layers or the functional layer and a substrate. As the glass plate disposed on the front face of the display device, it may be a glass plate on the front face of the display device itself or a glass substrate separate from the display device.

The optical filter according to the present invention may be an optical filter to be directly attached to the front face of the display device body not including a glass substrate or an optical filter to be disposed on the front face of a display device body including a glass substrate separate from the display device.

In the case that the optical filter of the present invention (hereinafter, it may be referred to as “a composite filter of the present invention”) is a composite filter, one or more kinds of functional layer laminated to the adhesive layer having the optical filter function may be a single layer or two or more layers. The above-mentioned two or more functions may be included in a single functional layer. In addition, a transparent substrate may be included in the functional layer or separately.

The composite filter of the present invention may be laminated to at least one side of the adhesive layer having the optical filter function or on both sides of the adhesive layer having the optical filter function. In addition, two or more adhesive layers according to the present invention may be included in the optical filter according to the present invention.

As a suitable embodiment of the composite filter of the present invention, there may be a composite filter which has at least the adhesive layer according to the present invention on the outermost surface, wherein the adhesive layer for direct attachment to a glass plate on the front face of a display device is the adhesive layer according to the present invention. As other suitable embodiment of a composite filter according to the present invention, there may be a composite filter which contains a glass substrate which is disposed on the front face of a display device separate from the display device, wherein the adhesive layer for direct attachment to the glass substrate is the adhesive layer according to the present invention. Further, the adhesive layer according to the present invention may be included as a layer for attaching two or more functional layers such as an electromagnetic wave shielding layer and an antireflective layer, or the adhesive layer according to the present invention may be included only as a layer for attaching two or more functional layers.

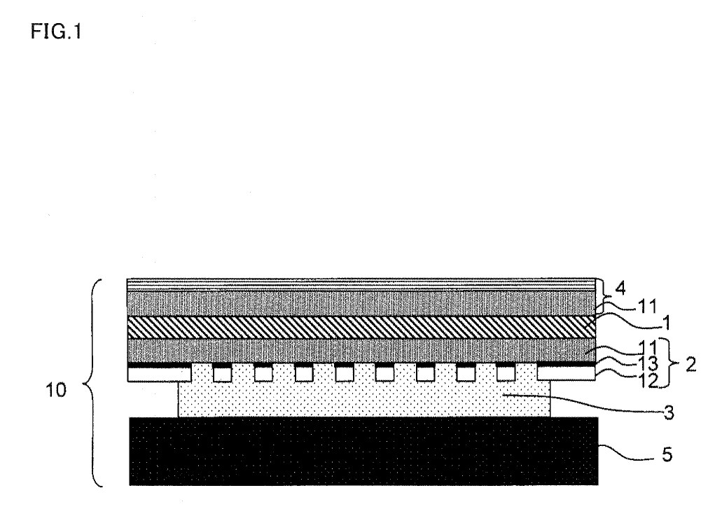

FIG. 1 is a view schematically showing a sectional view of an example of a laminate structure of an optical filter 10 of an embodiment of the present invention. As a layer structure of the optical filter 10 of FIG. 1, an adhesive layer 3, an electromagnetic wave shielding layer 2, an adhesive layer 1 having an optical filter function formed with the use of the adhesive composition according to the present invention and an antireflective layer 4 are laminated in this order on one surface of a glass substrate 5 (hereinafter, such a laminate structure may be referred to as “glass substrate 5/adhesive layer 3/electromagnetic wave shielding layer 2/adhesive layer 1 having an optical filter function/antireflective layer 4”). The optical filter 10 comprises a constituent in which the adhesive layer 1 having an optical filter function attaches substrates of two functional layers, more specifically, the transparent substrate 11 of the antireflective layer 4 and the transparent substrate 11 of the electromagnetic wave shielding layer 2. Also, the optical filter 10 comprises a constituent in which an electroconductive mesh layer side of electromagnetic wave shielding layer 2 is attached to the glass substrate 5 by the adhesive layer 3. In the above-mentioned process, the adhesive layer 3 may be the adhesive layer 1 having the optical filter function.

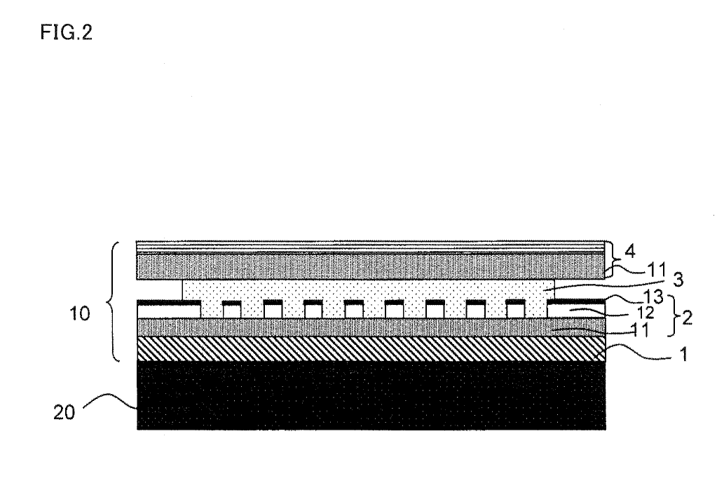

FIG. 2 is a view schematically showing a sectional view of other example of a laminate structure when the optical filter 10 of an embodiment of the present invention is attached to the front face of a plasma display panel 20. As a layer structure of the optical filter 10 in FIG. 2, an electromagnetic wave shielding layer 2, an adhesive layer 3 and an antireflective layer 4 are laminated in this order on one surface of an adhesive layer 1 having an optical filter function (adhesive layer 1/electromagnetic wave shielding layer 2/adhesive layer 3/antireflective layer 4). Herein, the adhesive layer 3 may be the adhesive layer 1 having the optical filter function.

In the case that a plurality of adhesive layers 1 having the optical filter function are present in the optical filter 10, the thickness of each adhesive layer 1 may be different.

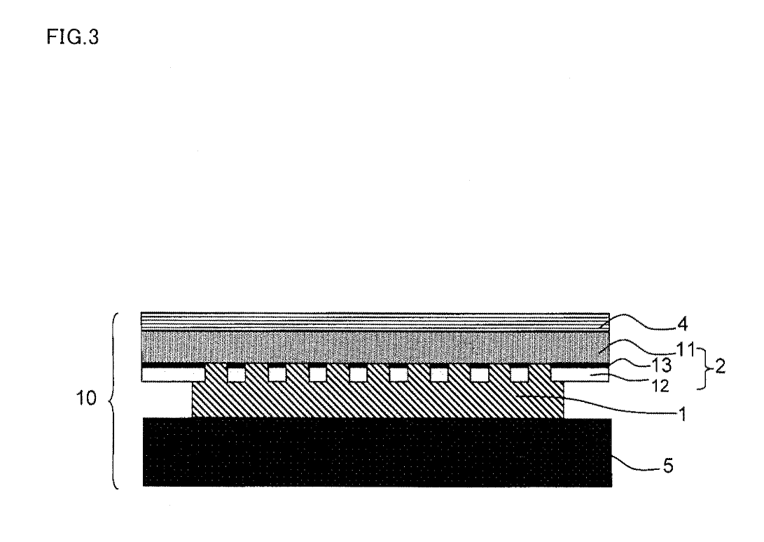

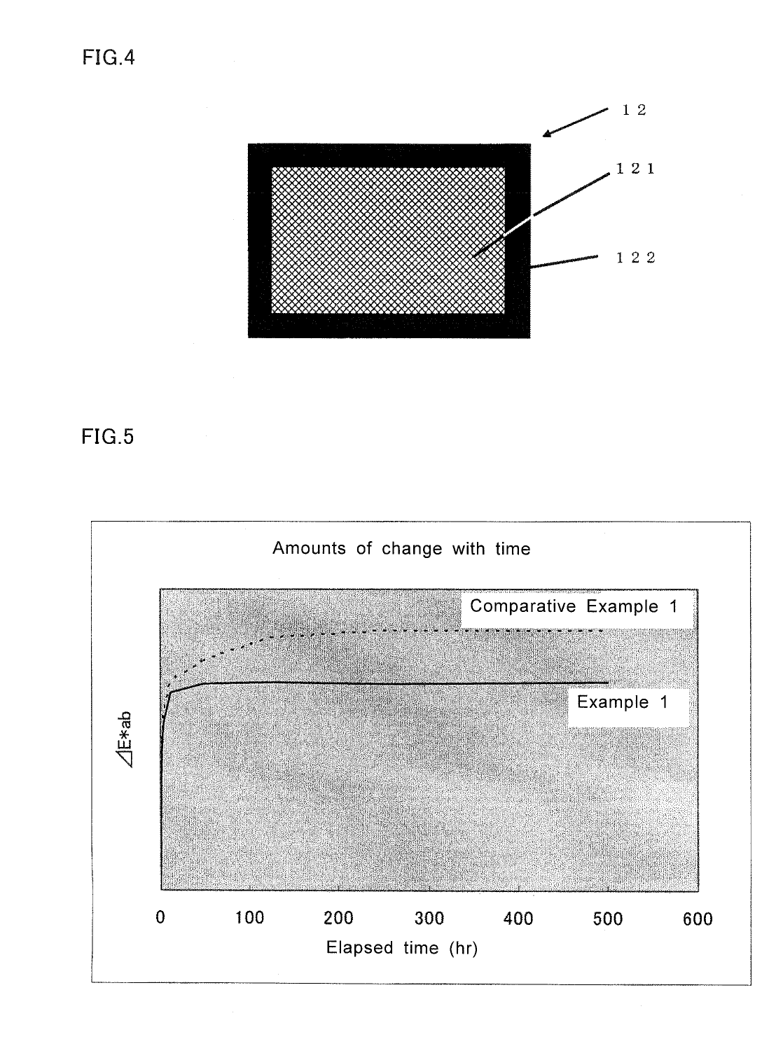

FIG. 3 is a view schematically showing a sectional view of another example of a laminate structure of the optical filter 10 of an embodiment of the present invention. As a layer structure of the optical filter 10 of FIG. 3, an adhesive layer 1, an electromagnetic wave shielding layer 2 and an antireflective layer 4 are laminated in this order on one surface of a glass substrate 5 (glass substrate 5/adhesive layer 1 having filter function/electromagnetic wave shielding layer 2/antireflective layer 4). There may be a composite filter in which electroconductive mesh layers 12 and 13 using metal and the adhesive layer 1 having the optical filter function are formed on one surface of the transparent substrate film 11 in this order, the antireflective layer 4 is formed on the other surface of the transparent substrate film 11, and the adhesive layer 1 adheres to the glass substrate 5, wherein the adhesive layer 1 having the optical filter function contains light absorbing agents including a light absorbing agents having an absorption band region at least from 800 to 1,100 nm, a light absorbing agents having an absorption band region at least from 570 to 610 nm, and a light absorbing agents having an absorption band region at least from 380 to 570 nm or from 610 to 780 nm, and the composite filter has at least each function including electromagnetic wave shielding function, near-infrared light absorption function, neon light absorption function, color correction function, and antireflection function (hereinafter, a composite filter of such a constitution may be referred to as “simple filter”).

The layer structure of the composite filter employed by the optical filter according to the present invention may not be particularly limited to, but includes, specifically, adhesive layer/electromagnetic wave shielding layer, adhesive layer/antireflective layer, adhesive layer/antiglare layer, adhesive layer/UV absorbing layer, adhesive layer/surface protective layer, adhesive layer/electromagnetic wave shielding layer/antireflective layer, adhesive layer/electromagnetic wave shielding layer/antiglare layer, adhesive layer/electromagnetic wave shielding layer/UV absorbing layer, adhesive layer/electromagnetic wave shielding layer/surface protective layer, adhesive layer/electromagnetic wave shielding layer/UV absorbing layer/antireflective layer, adhesive layer/electromagnetic wave shielding layer/UV absorbing layer/antiglare layer, glass substrate/adhesive layer/electromagnetic wave shielding layer, glass substrate/adhesive layer/antireflective layer, glass substrate/adhesive layer/antiglare layer, glass substrate/adhesive layer/UV absorbing layer, glass substrate/adhesive layer/surface protective layer, glass substrate/adhesive layer/electromagnetic wave shielding layer/antireflective layer, glass substrate/adhesive layer/electromagnetic wave shielding layer/antiglare layer, glass substrate/adhesive layer/electromagnetic wave shielding layer/UV absorbing layer, glass substrate/adhesive layer/electromagnetic wave shielding layer/surface protective layer, glass substrate/adhesive layer/electromagnetic wave shielding layer/UV absorbing layer/antireflective layer, glass substrate/adhesive layer/electromagnetic wave shielding layer/UV absorbing layer/antiglare layer or the like (“adhesive layer” exemplified above is “adhesive layer having optical filter function” which is an essential component of the present invention). In the above-mentioned examples, the adhesive layer and/or the transparent substrate may be further contained between two functional layers. As the adhesive layer used between two functional layers, the adhesive layer having the optical filter function may be used. Also, in the optical filter according to the present invention, a near-infrared light absorbing layer, a neon light-absorbing layer or a color correcting layer imparting the optical filter function may be further provided besides the adhesive layer having optical filter functions according to the present invention.

Hereinafter, the adhesive layer having an optical filter function, the functional layer of one or more kinds of the present invention, and further, an adhesive layer which is different from the adhesive layer having optical filter function and the transparent substrate will be described in this order.

### <Adhesive Layer Having Optical Filter Functions>

The adhesive layer having optical filter functions in the present invention is formed by the use of the adhesive composition according to the present invention and at least contains the above-specified block copolymer (I), the resin (II) or the resin (IV) having the glass transition temperature of 60° C. or more and one or more light absorbing agents (III) having light absorption of a predetermined wavelength range. If required, other compounds may be contained.

The adhesive layer having optical filter functions of the present invention can be formed by an arbitrary method suited to the object. The adhesive layer is preferably formed by a method using no or less harmful component which causes deterioration of light absorbing agent, the block copolymer or the like and requiring no excessive temperature or pressure in order to prevent deterioration of light absorbing agent and the block copolymer. One of such a method includes a method in which the adhesive composition for optical filter of the present invention is further dissolved in a solution if required, applied or extruded on a release film or a functional layer to be hereinafter described, and dried if required.

As a method for applying the adhesive composition in which the light absorbing agent, the block copolymer (I) and the resin (II) or the resin (IV) having the glass transition temperature of 60° C. or more are dissolved or dispersed uniformly on a support, there can be used various coating methods, for example, dipping, spraying, brush coating, meyer bar coating, doctor blade coating, gravure coating, gravure reverse coating, kiss reverse coating, three-roll reverse coating, slit reverse die coating, die coating, comma coating and the like.

A thickness of the adhesive layer of the present invention is appropriately selected according to the purpose. Generally, the thickness when dried is selected to be in the range of 10 to 5,000 μm, but may not be limited thereto. In the case that two or more functional layers are attached or the adhesive layer is directly attached to a glass plate on the front face of a display, the thickness when dried is preferably 10 to 500 μm. When the adhesive layer is directly attached to a glass plate on the front face of a display, and particularly the thickness of the adhesive layer is 200 μm or more, the adhesive layer can function effectively as an impact-resistant layer which increases impact resistance of the display device.

In the case that the optical filter of the present invention is composed of only the adhesive layer having optical filter functions, the optical filter is a single layer when it is used as the adhesive layer. At the time of distribution, a release film such as PET on which a silicon resin or a fluorine-based resin is applied or the like may be attached on both sides or one side of the optical filter.

In the adhesive layer having the optical filter function of the present invention, it is preferable to set a kind of NIR absorbing agent, a content of NIR absorbing agent in the adhesive layer, a thickness of the adhesive layer and the like so that the absorption amount of near-infrared light in the wavelength range of 800 to 1,100 nm is a transmittance of 30% or less, more preferably 10% or less. In particular, it is preferable that the transmittance in 825 nm is 20% or less, the transmittance in 850 nm is 20% or less, the transmittance in 880 nm is 5% or less and the transmittance in 980 nm is 5% or less.

Also, in the adhesive layer, when the center wavelength of Ne light region is set to 590 nm, it is preferable to set a kind of Ne light absorbing agent, a content of Ne light absorbing agent in the adhesive layer, a thickness of the adhesive layer and the like so that a transmittance of light in 590 nm is 50% or less.

It is preferable for the adhesive layer having optical filter functions of the present invention to have adhesiveness of such a degree that no peeling and no slippage are generated so that semipermanent use is capable and that a relatively easy peeling from a smooth surface is possible even after attachment. The glass adhesion of a coating layer with a thickness of 25 μm when dried is preferably from 0.5 to 30 N/25 mm. The glass adhesion can be measured by attachment to a sodium glass and peeling at 90° C. at a rate of 200 mm/min with reference to the test of JIS Z0237-2000. The glass adhesion is more preferably from 1 to 20 N/25 mm, even more preferably from 5 to 15 N/25 mm.

The adhesive layer having optical filter functions of the present invention has an excellent resistance and hardly causes a change of adhesion after long term use under high temperature and high humidity. Specifically, in the case of carrying out a heat resistance test as described below, difference in values of glass adhesion of the adhesive layer before and after being left for 500 hours in an atmosphere of high temperature (for example, ambient temperature of 80° C. and a relative humidity of 10% or less) or in an atmosphere of high temperature and high humidity (for example, ambient temperature of 60° C. and relative humidity of 90%) is preferably 10 N/25 mm or less. The glass adhesion of the adhesive layer after being left for 500 hours is preferably 1 N/25 mm or more, more preferably 5 N/25 mm or more.

It is preferable that the adhesive layer of the present invention has high transparency since the adhesive layer is used on the face of an image display of a display device and haze of 3% or less. The haze herein means a value measured by a method in accordance with JIS K7105-1981. Specifically, the haze value can be measured using a sample which is made by attaching the adhesive layer to a glass plate with a thickness of 1.2 mm and attaching an easy adhering surface of PET film, for example, Cosmoshine A-4100 (product name, manufactured by Toyobo Co., Ltd.), to the adhesive layer on the side opposite to the glass plate so as to laminate the PET film on the adhesive layer.

In the case of using the adhesive layer 1 having an optical filter function which does not contact with both of the glass plate and the electroconductive mesh layer surface of the electromagnetic wave shielding layer as shown in the FIG. 1, as a near-infrared light absorbing agent contained in the adhesive layer 1, in particular, a phthalocyanine-based compound and/or a diimmonium-based compound is suitably used from the viewpoint of having both high transmittance in the visible range and high near-infrared absorption property.

In the case of using the adhesive layer 1 having an optical filter function at a place which contacts with both of the glass plate and the electroconductive mesh layer side of the electromagnetic wave shielding layer or a place with contacts with any of the glass plate or the electroconductive mesh layer surface of the electromagnetic wave shielding layer as shown in the FIG. 3, as a near-infrared light absorbing agent contained in the adhesive layer 1, in particular, a combination of three or more kinds out of the above-mentioned phthalocyanine-based compounds (A) to (D) that relatively hardly cause change in spectral characteristic in sodium ion of the glass plate or metallic ion of the electroconductive mesh layer or an inorganic near-infrared light absorbing agent such as a compound based on cesium and tungsten may be suitably used.

The adhesive layer having optical filter functions of the present invention has an excellent durability of an optical filter function and hardly causes change in spectral characteristic attributable to deterioration of light absorbing agent even after a long-term use at high temperature and high humidity. Specifically, in the case of carrying out a heat resistance test as described below, it is desirable that both differences Δx and Δy in chromaticity (x, y) of the test sample before and after left in an atmosphere of high temperature are 0.03 or less, preferably 0.02 or less, more preferably 0.015 or less. In addition, in the case of carrying out the heat and humidity resistance test as described below, it is desirable that both differences Δx and Δy in chromaticity (x, y) of the test sample before and after left in an atmosphere of high temperature and high humidity are 0.03 or less, preferably 0.02 or less, more preferably 0.015 or less.

By the use of the specific block copolymer (I) as well as the resin (IV) having the glass transition temperature of 60° C. or more, the adhesive layer of the present invention hardly causes a deterioration of the light absorbing agent at high temperature compared to the case of using the specific block copolymer (I) alone.

Firstly, the adhesive layer of the present invention is attached to a glass (product name: PD-200, manufactured by Asahi Glass Co., Ltd.; thickness: 2.8 mm) followed by laminating a PET film (product name: A4100, manufactured by Toyobo Co., Ltd.; thickness: 50 μm) on the adhesive layer, thus a sample for resistance test is prepared. Chromaticity (x, y) of the sample for resistance test before the resistance test is measured. The chromaticity can be measured, for example, with the use of spectral photometer (product name: UV-3100PC, manufactured by Shimadzu Corporation).

Secondly, the resulting sample for resistance test is left for 1,000 hours in an atmosphere of high temperature (for example, ambient temperature of 80° C., relative humidity of 10% or less) or in an atmosphere of high temperature and high humidity (for example, ambient temperature of 60° C., relative humidity of 90%) and then measured its chromaticity after the durability test in the same manner as described above. Differences Δx and Δy in chromaticity (x, y) are calculated from the measured values of the chromaticity before and after left in the atmosphere of high temperature or in the atmosphere of high temperature and high humidity.

### <Electromagnetic Wave Shielding Layer>

The electromagnetic wave shielding layer has a function to shield electromagnetic wave emitted from a plasma display panel or the like.

As the electromagnetic wave shielding layer, it is possible to apply various forms which are conventionally known. It is possible to use a transparent continuous (not having a mesh opening formed) thin layer such as silver, ITO (Indium Tin Oxide), ATO (Antimony doped Tin Oxide) or the like besides the below-mentioned electroconductive mesh layer. However, from the viewpoint of having both transparency and electromagnetic wave shielding property, an electroconductive mesh layer such as metal or the like is preferable. Hereinafter, an embodiment of the electromagnetic wave shielding layer using the electroconductive mesh layer will be mainly described.

The electromagnetic wave shielding layer which is suitably used in the present invention has a laminate structure that a transparent substrate 11 and an electroconductive mesh layer 12 are laminated in this order as shown in FIG. 1.

(Electroconductive Mesh Layer)

The electroconductive mesh layer 12 is a layer which has an electrical conductivity and thereby has an electromagnetic wave shield function, wherein the layer itself is opaque but has a large number of openings in the form of a mesh, thus satisfying both electromagnetic wave shielding function and optical transparency.

Also, the electroconductive mesh layer mainly contains a metal layer in general, and normally in addition, the electroconductive mesh layer contains a blackened layer or anticorrosive layer having an electrical conductivity. Particularly, in the case of forming an electroconductive mesh layer using electrolytic plating described below, the electroconductive mesh layer further contains an electroconductively treated layer as a layer of structure.

A non-electroconductive layer may be further formed in part or whole surface of both sides of the electroconductive mesh layer including sides thereof. As an example of the non-electroconductive layer, there may be a non-electroconductive anticorrosive layer, a blackened layer or the like. However, when an anticorrosive layer or a blackened layer is electroconductive, such layer is included in the electroconductive mesh layer of the present invention. Such electroconductive layer can be a constituent layer of the electroconductive mesh layer.

[Shape of the Mesh]

A shape of the mesh may be any kind and not particularly limited, but a form of opening is typically a square. As the form of opening, there may be, for example, a triangle such as a regular triangle, a quadrangle such as a square, a rectangle, a lozenge, a trapezoid, a polygon such as a sexanglular, a circular form or an oval figure. The mesh has plural openings of such a shape. A portion between openings forms a line part which comparts the openings. The line part has normally a uniform width and a line-like shape. Normally, the openings and the portion between openings are usually identical in shape and size on the whole area.

Specifically, for example, a width of line part (line width) which is the portion between the openings is 50 μm or less, preferably 15 μm or less, from the viewpoint of aperture ratio and invisibility of mesh. However, the minimum width may be preferably 5 μm or more from the viewpoint of ensuring the electromagnetic wave shielding function and preventing breakage.

A bias angle of a mesh area, which is an angle between the line part of the mesh and an outer circumference of the composite filter, may be accordingly set to an angle which hardly causes moire in view of pixel pitch or light emitting property of an applying display.

In addition, it is preferable that an opening width of the opening part, that is defined as [(line pitch) minus (line width)], is 100 μm or more, more preferably 150 μm or more. However, it is preferable that the maximum opening width is 3,000 μm or less from the viewpoint of ensuring the electromagnetic wave shielding function. Also, as for the line width and the opening width, it is preferable that the aperture ratio is 60% or more from the viewpoint of optical transparency and hardly remaining bubble in the openings when forming a transparent protective layer. It is also preferable that the aperture ratio is 97% or less from the viewpoint of ensuring the electromagnetic wave shielding function. The aperture ratio can be calculated in the following formula:

Aperture ratio=[(opening width)²/(line pitch)²]×100%

[Earthing Area and Mesh Area]

It is more preferable that the electroconductive mesh layer 12 contains an earthing area 122 besides the mesh area 121 in the planar direction as shown in the electroconductive mesh layer 12 illustrated chematically in the plane view of FIG. 2 from the viewpoint of easy earthing. The earthing area can be formed in part or whole circumference of an image display area rim so that the earthing area does not interfere with image display. The mesh area is an area capable of covering all image display area of the display to which the composite filter is applied. The earthing area is an area for earthing. The image display area at least means a region in which the display substantially shows images (substantial image display area), but the meaning may include, as a matter of convenience, the entire inner region of frame defined by an outer frame of the display when viewed from an observer side. This is because when there is a black region (bordering) on the inside of the frame and on the outside of the substantial image display area, the region is originally not an image display area, however, the region is viewed by the observer, who may feel uncomfortable if the appearance of the region is different from the substantial image display area.

The earthing area basically does not need the mesh, however, the mesh having openings may be provided for the purpose of prevention of warpage of the earthing area or the like.

A thickness of the electroconductive mesh layer may not be necessarily as the same thickness as that of the mesh area and the earthing area, but the thickness of the electroconductive mesh layer, the mesh area and the earthing area are normally the same. The thickness of the electroconductive mesh layer is at least 1 to 20 μm in the mesh area from the viewpoint of the electromagnetic wave shielding function. It is desirable that the thickness of the electroconductive mesh layer is 1 to 5 μm, more preferably 1 to 3 μm from the viewpoint of thinner film thickness, good visibility of images (when viewed obliquely), less mixing of bubble into the opening when forming the surface protective layer due to uneven height between opening and line part, high yield due to short processing steps and so on.

A height of the line part of the mesh area in the electroconductive mesh layer is the same as the thickness of the electroconductive mesh layer in the case the line part consists of the electroconductive mesh layer alone from the viewpoint of uneven height between the opening and the line part. However, for example, in the case that a non-electroconductive blackened layer and a non-electroconductive anticorrosive layer are formed, the height of the line part is a total thickness of the electroconductive mesh layer, the non-electroconductive blackened layer and the non-electroconductive corrosion layer.

[Method of Forming Electroconductive Mesh Layer]

A material and method of forming the electroconductive mesh layer having the mesh area and the earthing area of the present invention may not be particularly limited, and conventionally known materials and methods of forming an electromagnetic wave shielding sheet can be accordingly employed.

The methods of forming the electroconductive mesh layer having the mesh area includes, but is not limited to, the following methods (1) to (4):

(1) a method wherein an electroconductive ink is printed in pattern on a transparent substrate film and a metal plating is performed on thus formed conductive ink layer (for example, JP-A No. 2000-13088);

(2) a method wherein an electroconductive ink or a photosensitive coating liquid containing a chemical plating catalyst is coated on the whole surface of a transparent substrate film and thus formed coating layer is processed to be in a mesh form by photolithographic method followed by metal plating on the mesh (for example, Advanced Materials Research Group New Technology Research Laboratory of SUMITOMO OSAKA CEMENT Co., Ltd., “Photosensitive Catalyst for Electro-less Plating with Fine Pattern”[online], no date of posting, SUMITOMO OSAKA CEMENT Co., Ltd., [searched on Jan. 7, 2003], Internet <URL:http://www.socnb.com/product/hproduct/display.html>);

(3) a method wherein a transparent substrate film and a metallic foil are laminated via an adhesive followed by processing the metallic foil in a mesh form by a photolithographic method (for example, JP-A No. 11-145678); and

(4) a method wherein a metallic thin film is formed on one surface of a transparent substrate film by sputtering or the like so as to form an electroconductively treated layer, then a metal layer is formed as a metal plated layer on the transparent substrate film by electrolytic plating, and the metal plated layer and the electroconductively treated layer on the metal plated transparent substrate film are formed in the form of a mesh by photolithography (for example, Japanese Patent No. 3502979 and JP-A No. 2004-241761).

Among these methods, the method (4) is particularly preferable from the view point of a thin film thickness of 5 μm or less, good visibility of images when viewed obliquely, less mixing of bubble when forming the surface protective layer, high yield by short processing steps, low cost and so on. Therefore, hereinafter, the method of forming the electroconductive mesh layer on the transparent substrate film by the method (4) will be described in detail.

In this method, an electroconductive layer is formed without the mesh, which is a state before becoming the electroconductive mesh layer, on one surface of the transparent substrate film, followed by processing the electroconductive layer in a mesh form so as to have the electroconductive mesh layer.

[Electroconductively Treated Layer]

The electroconductively treated layer is a layer for ensuring electrical conductivity which is necessary for plating used for subjecting a surface of a transparent substrate film to be used to a electroconductive treatment so that a metal plated layer can be formed by means of electrolytic plating when the film is a resin film of electric insulation. As a method for the electroconductive treatment, any known method for forming a thin film of electroconductive materials can be used. As the electroconductive materials, for example, there may be metal such as gold, silver, copper, nickel, chrome or mixed metal alloy of the metals (for example, nickel-chromium alloy). Alternatively, transparent metallic oxide such as tin oxide, ITO, ATO or the like may be used. The electroconductively treated layer can be formed by any known thin film forming method such as a vacuum deposition method, a sputtering method, a nonelectrolytic plating method or the like using the above-mentioned materials. The electroconductively treated layer may be either a single layer or multiple layers (for example, a laminated layer of a nickel-chromium alloy layer and a copper layer). Because it is only necessary to obtain electrical conductivity required to plate, a thickness of the electroconductively treated layer is preferably very thin, around 0.001 to 1 μm, from the viewpoint of thinning the thickness of electroconductive mesh layer as a whole.

[Metal Plated Layer]

The metal plated layer is formed on the surface of the electroconductively treated layer by the electrolytic plating method. As materials of the metal plated layer, materials that can obtain electrical conductivity required for the electromagnetic wave shielding function may be used. Metals include, for example, gold, silver, platinum, copper, tin, iron, nickel, chrome, aluminum or alloy of the above-mentioned metals. Among them, preferable materials are copper or copper alloy from the viewpoint of easy plating and electrical conductivity. Also, the metal plated layer may be either a single layer or multiple layers.

In addition, a thickness of the metal plated layer is preferably set to a thickness which is capable of forming the electroconductive mesh layer of thin film thickness, for instance, a total thickness of the electroconductively treated layer and the metal plated layer is 5 μm or less, since, in the method (4) describing in detail, a thin film having a thickness of 5 μm or less is preferred at least at the mesh area of the electroconductive mesh layer.

[Blackened Layer]

The blackened layer is provided as necessary at least on one surface of the metal plated layer to absorb outside light and increase visibility and contrast of image. The blackened layer is provided by any of the following methods such as roughening a surface of the metal plated layer, imparting light-absorbing property over visible light range (blackening) or using the above-mentioned two methods in combination.

Specifically, as the method of providing the blackened layer, formation of metal oxide and metal sulfide or various methods may be employed. In the case that a surface to provide the blackened layer is made of iron, an oxide film (blackened film) having a thickness of around 1 to 2 μm is preferable. In the case that a surface to provide the blackened layer is made of copper, the blackened layer is preferably a particle layer of copper-cobalt alloy, a nickel sulfide layer, a copper oxide layer or the like.

The blackened layer is provided at least on the observation side. However, if the blackened layer is provided on the other side where the adhesive layer is provided, that is, on the display side, a stray light from the display can be absorbed, thus the visibility of image can be increased.

When the electroconductive mesh layer is formed by the electrolytic plating and the blackened layer is provided on the transparent substrate film side of the electroconductive mesh layer, for example, the following “(A method)” and “(B method)” can be employed:

(A method) a method wherein the electroconductively treated layer provided on the transparent substrate film is formed as a layer of black color used as the blackened layer at the same time, and the metal plated layer is formed on thereon; and

(B method) a method wherein the electroconductively treated layer is formed on the transparent substrate film as the transparent electroconductively treated layer using ITO or the like followed by forming a electroconductive blackened layer on the transparent electroconductively treated layer, and metal plated layer is formed on the electroconductive blackened layer of the electroconductively treated layer comprising the transparent electroconductively treated layer and the electroconductive blackened layer.

A preferable black concentration of the blackened layer is 0.6 or more. A measuring method of the black concentration is in such a manner that GRETAG SPM100-11 of COLOR CONTROL SYSTEM (product name, manufactured by Kimoto Co., Ltd.) is set to have an observation view angle of 10° C., an observation light source of D50 and an illumination type of concentration standard ANSIT, and a test sample is measured after white calibration. As a light reflectance of the blackened layer, 5% or less is preferable. The light reflectance may be measured by means of Haze meter HM150 (product name, manufactured by Murakami Color Research Laboratory) in accordance with JIS-K7105.

In addition, the black concentration may be expressed by the reflection value Y measured by a calorimeter in place of the measurement of the reflectance. In this case, a preferable black concentration is Y value of 10 or less.

[Anticorrosive Layer]

The anticorrosive layer is preferably provided so as to cover the surface of the metal plated layer or the blackened layer. The surface of the electroconductive mesh layer (the metal plated layer or the blackened layer thereof) is finally covered with the adhesive layer or functional layer at least in the mesh area, however, the surface of the electroconductive mesh layer is exposed during the production process before forming the adhesive layer or functional layer. Thus, the anticorrosive layer is provided to prevent corrosion and to prevent the blackened layer from being chipped or deformed. For the above purposes, it is preferable to provide the anticorrosive layer at least on the blackened layer.

As the anticorrosive layer, for example, an oxide of nickel, zinc and/or copper or a chromate-treated layer may be used. As a forming method of the oxide of nickel, zinc and/or copper, a known plating method may be used. A thickness of the anticorrosive layer is around 0.001 to 1 μm, preferably 0.001 to 0.1 μm, from the viewpoint of attaining the purpose and avoiding excessive level of performance as well as decreasing the thickness as much as possible.

[Formation of Mesh]

Next, a process of preparing the electroconductive mesh layer by forming the mesh in the electroconductive layer provided as above (hereinafter, a laminated layer of the transparent substrate film and the electroconductive layer may be referred to as a “laminate”) on the transparent substrate film by a photolithographic method will be described.

A resist layer is provided on the surface of the electroconductive layer laminated on the transparent substrate film, and the resist layer is processed to have a mesh pattern. Then, an area of the electroconductive layer which is not covered by the resist layer is etched to remove. The resist layer is removed, and thus, the electroconductive mesh layer with the mesh area is prepared. This method can use existing facilities and perform many processes continuously, and production excellent in quality, production efficiency, yield, cost or the like is capable.

In the mesh forming process by the photolithographic method, it is preferable that a roll-shaped laminate which is continuously rolled in a continuous belt-shaped condition is processed (it may be referred to as a winding process or a roll-to-roll processing). The laminate is consecutively or intermittently conveyed and may be subject to each process of masking, etching and resist removing in a stretched condition without looseness.

In the masking, for example, a photosensitive resist is applied on the electroconductive layer and is subject to contact exposure using a photomask having a predetermined mesh pattern after drying, followed by water-development, film-hardening treatment, and baking. Any of negative photosensitive resist and positive photosensitive resist can be used. In the case of the negative photosensitive resist, the mesh pattern of pattern plate is a positive illusion whose line part is transparent. On the other hand, in the case of the positive photosensitive resist, the mesh pattern of pattern plate is a negative illusion whose opening is transparent. Also, an exposure pattern is a pattern having a predetermined mesh form, which has at least a pattern of mesh area. Further, if necessary, the exposure pattern has a pattern of the earthing area in peripheral area of the mesh area.

In the resist forming, in the case of the winding process, a resist such as casein, PVA, and gelatin is applied on the surface of the electroconductive layer to which the mesh area is formed by a method such as dipping, curtain coating, flow coating or the like while the continuous belt-shaped laminate is conveyed consecutively or intermittently. For the resist forming, a dry film resist may be used instead of coating. In this case, workability can be increased. In the case of casein resist, the baking is performed at 200 to 300° C. The temperature is preferably as low as possible from the viewpoint of preventing curve of the laminate.

When etching is continuously conducted, a solution of ferric chloride or copper chloride, which is easily capable of cyclic usage, may be preferably used as an etchant. The etching process is basically the same as a process using a facility for producing a shadow mask for cathode-ray tube of color TV, in which a continuous belt-shaped steel product, particularly a thin film having a thickness of 20 to 80 μm. After the etching, water washing, resist stripping by an alkaline solution, rinsing and drying may follow.

It is preferable that the electroconductive mesh layer in the present invention as mentioned above has a surface resistivity in the range of 10⁻⁶Ω/□ to 5Ω/□, more preferably in the range of 10⁻⁴Ω/□ to 3Ω/□. Generally, the electromagnetic wave shielding property can be measured by surface resistivity. When the surface resistivity is lower, the electromagnetic wave shielding property is better. A value of the surface resistivity herein refers to the value which can be measured by the method disclosed in JIS K7194 “Testing method for resistivity of conductive plastics with a four-point probe array” with the use of surface resistivity meter (product name: Loresta GP, manufactured by DIA INSTRUMENTS Co., Ltd.).

(Transparent Substrate)

The transparent substrate is a layer constituting a part of the electromagnetic wave shielding layer and a layer which can be a substrate to laminate the electroconductive mesh layer via the adhesive layer, if required.

The transparent substrate 11 is a layer to reinforce the electroconductive mesh layer with low mechanical strength. Further, the transparent substrate 11 may be a layer having a UV absorption function added in the embodiment of the simple filter. Hence, the transparent substrate film may be selected according to the purpose in consideration of performances such as heat resistance and so on accordingly if the film has the mechanical strength and the light transparency, and further the UV absorption function in the case of the embodiment of the simple filter. As such a transparent substrate, a resin film (or a resin sheet) as the transparent substrate film can be used.

Examples of transparent resins used for materials for the resin film include a polyester resin such as polyethylene terephthalate, polybutylene terephthalate, polyethylene naphthalate, a terephthalic acid-isophthalic acid-ethylene glycol copolymer, and a terephthalic acid-cyclohexanedimethanol-ethylene glycol copolymer; a polyamide resin such as Nylon 6; a polyolefin resin such as polypropylene, polymethylpentene and a cycloolefin polymer; an acrylic resin such as polymethylmethacrylate; a styrene resin such as polystyrene, a styrene-acrylonitrile copolymer; cellulose resin such as triacetyl cellulose; and a polycarbonate resin.

These resins are used solely or in combination as a mixed resin (including a polymer alloy). The layer structure of the transparent substrate is used as a single layer or a laminate composed of two or more layers. In the case of the resin film, a uniaxially oriented film or a biaxially oriented film is preferably used from the viewpoint of mechanical strength.

A thickness of the transparent substrate is basically not particularly limited and may be determined according to the application. The thickness is generally from 12 to 1,000 μm, more preferably from 50 to 500 μm, and even more preferably from 50 to 200 μm. If the thickness is within the range, the transparent substrate has sufficient mechanical strength so that warpage, loosening, breaking or the like can be prevented and the transparent substrate can be easily supplied and processed in a continuous belt-shaped state.

The transparent substrate in the present invention includes a resin plate besides the resin film (including the resin sheet). However, the transparent substrate is preferably thin from the viewpoint of avoiding increase in total layer thickness caused by laminating NIR absorption, Ne light-absorption and color correcting on each filter film so as to decrease the thickness of the composite filter.

For the above-mentioned reasons, the resin film is more preferable than the resin plate as the form of the transparent substrate. Among the resin films, the polyester-based resin film such as polyethylene terephthalate and polyethylene naphthalate is particularly preferable in terms of transparency, heat resistance, costs and so on. Further, the biaxially oriented polyethylene terephthalate film is most preferable. Higher transparency is better for the transparent substrate, and specifically, a film having a light transparency in visible light transmittance of 80% or more is preferable.

In the embodiment of the simple filter, the transparent substrate film has a UV absorption function as an essential function. For this purpose, an UV absorbing agent may be kneaded in the resin of the transparent substrate film, a surface coating layer including the UV absorbing agent is provided on the surface as a layer of structure of the transparent substrate film, or both means may be performed. The surface to which the surface coating layer is provided may be either one side or both sides of the transparent substrate film.

In the embodiment of the simple filter, in consideration of providing the surface protective layer on one side of the transparent substrate film, if the surface coating layer containing the UV absorbing agent is formed on the side to which the surface protective layer is provided, the surface coating layer may also be used as the surface protective layer.

As the UV absorbing agent, for example, known compounds including the above-mentioned organic compound such as benzotriazole and benzophenone, or the above-mentioned inorganic compound such as particulate zinc oxide and cerium oxide can be used.

The surface coating layer containing the UV absorbing agent (UV absorbing layer) may be formed by coating the composition having the UV absorbing agent added to a resin binder in a known method. A resin of the resin binder includes a thermoplastic resin such as a polyester resin, a polyurethane resin, and an acrylate resin; a thermosetting resin or an ionizing radiation curing resin consisting of monomers such as epoxy, acrylate, and methacrylate, or prepolymers thereof, and a curable resin such as a two-pack curable urethane resin.

The resin in the transparent substrate can contain a known additive such as filler, a plasticizer, and an antistatic agent as needed without departing from the effect of the invention.

A known adhension-enhancing treatment such as a corona discharge treatment, a plasma treatment, an ozone treatment, a flame treatment, and a primer treatment may be accordingly performed on the surface of the transparent substrate.

(Bonding Agent Layer)

The bonding agent layer (not shown in the electromagnetic wave shielding layer of FIG. 1) may be used to attach the transparent substrate and the electroconductive mesh layer depending on a forming method. If the bonding agent layer is capable of attaching the electroconductive mesh layer and the transparent substrate, types are not particularly limited. In the present invention, it is preferable the bonding agent layer has etching resistance since after the metallic foil which constitutes the electroconductive mesh layer and the transparent substrate are attached via the bonding agent layer, the metallic foil is etched into the mesh form. There may be, specifically, an acrylate resin, a polyester resin, a polyurethane resin, an epoxy resin, a polyurethanester resin and so on. The bonding agent layer used in the present invention may be either ultraviolet curing type or thermosetting type. Particularly, the polyurethane resin, the acrylate resin or the polyester resin is preferable from the viewpoint of adhesion with the transparent substrate.

The metallic foil to form the electroconductive mesh layer and the transparent substrate can be attached by a dry lamination method or the like via the bonding agent layer. It is preferable a film thickness of the bonding agent layer is in the range of 0.5 μm to 50 μm, more preferably in the range of 1 μm to 20 μm, since the transparent substrate and the electroconductive mesh layer can be firmly attached and also the transparent substrate can avoid the influence of etchant such as ferric chloride or the like upon etching to form the conductive mesh layer.

### <Antireflective Layer>

It is preferable to form a so-called antiglare layer and/or so-called antireflective layer on the uppermost layer of the composite filter of the present invention as a means to decrease the reflection of background by mirror reflection of outside light on the surface of the image display device, image whitening and deterioration of image contrast. The former antiglare layer employs a method in which the antiglare layer acts like frosted glass to scatter or diffuse a light thereby blurring away a background image caused by external light.

The latter antireflective layer is a so-called narrowly-defined antireflective layer, which employs a method to obtain an excellent antireflection effect by alternately laminating a high-refractive index material and a low-refractive index material, allowing multi-coating so that the outermost surface is a low refractive index layer, allowing lights reflected on each layer interfaces to offset by interference, and thereby suppressing reflection on the surface.

The antireflective layer is generally formed by a vapor phase method wherein a film is formed by alternately evaporating a low refractive index material, typically MgF₂ or SiO₂, a high refractive index material, such as TiO₂ and ZrO₂.

To improve the effect of antireflection, it is preferable that a refractive index of the low refractive index layer is 1.45 or less. As a material having these characteristics, there may be, for example, an inorganic base low-reflection material in which an inorganic material such as LiF (refractive index n=1.4), MgF₂ (refractive index n=1.4), 3NaF.AlF₃ (refractive index n=1.4), AlF₃ (refractive index n=1.4), Na₃AlF₆ (refractive index n=1.33), SiO₂ (refractive index n=1.45) or the like is microparticulated and contained in an acrylic resin, an epoxy base resin or the like, or an organic low-reflection material such as a fluorine- and silicone-based organic compound, a thermoplastic resin, a thermosetting resin, a radiation curing resin or the like.

Further, a material mixed sol which dispersed silica superfine particle of from 5 to 30 nm in water or organic solution and fluorine-based film forming agent can be used. As a sol that from 5 to 30 nm of the silica superfine particle disperse in a water or an organic solvent, a known silica sol obtained by condensing active silica which is known by a dealkalization method of an ion exchange of an alkali metal ion or the like in silicate alkali salt or a method that silicate alkali salt neutralize by mineral acid, a known silica sol obtained by hydrolyzing and condensing alkoxysilane in the presence of a basic catalyst in an organic solvent, further an organic solvent-based silica sol obtained by substituting water in the water-based silica sol to organic solvent by distillation method or the like are used. These silica sol can be used both water base and organic solvent base. When organic solvent-based silica sol is produced, it does not completely need to replace water to organic solvent. The silica sol contains solid content of 0.5 to 50 weight % concentration as SiO₂. A variety of configuration of silica superfine particle in the silica sol such as sphere, needle, and plate are available. As film forming agent, alkoxysilane, metallic alkoxide, hydrolysate of metallic salt and polysiloxane denaturalized by fluorine are available.

The low refractive index layer may be obtained as follows. After the above-mentioned materials are diluted in a solvent and provided on the high refractive index layer by a wet coating method such as spin coating, roll coating or printing or a vapor phase method such as vacuum deposition, sputtering, plasma CVD and ion plating, followed by drying, the formed layer is cured by heat, radiation (in the case of an ultraviolet light, the above-mentioned photopolymerization initiator is used) or the like.

The formation of high refractive index layer may be performed by using a high refractive index binder resin to increase a refractive index, by adding a superfine particle having high refractive index in the binder resin, or by using both methods. It is preferable the refractive index of high refractive index ratio is in the range of from 1.55 to 2.70.

As the resin for high refractive index layer, arbitrary transparent resin can be used, and a thermosetting resin, a thermoplastic resin, a radiation (including ultraviolet) curable resin and so on can be used. As the thermosetting resin, a phenol resin, a melamine resin, a polyurethane resin, an urea resin, a diarylphthalate resin, a guanamine resin, an unsaturated polyester resin, an aminoalkyd resin, a melamine-urea condensation resin, a silicon resin, a polysiloxane resin and so on can be used. If required, a curing agent such as a cross-linking agent and a polymerization initiator, a polymerization accelerator, a solvent, a viscosity modifier and so on can be added.

The superfine particle having high refractive index include, for example, a particle which can also obtain the effect of ultraviolet shielding, such as ZnO (refractive index n=1.9), TiO₂ (refractive index n=2.3 to 2.7) and CeO₂ (refractive index n=1.95), and a particle which has the antistatic effect imparted to prevent attachment of dust, such as antimony-doped SnO₂ (refractive index n=1.95) and ITO (refractive index n=1.95). Other particles include Al₂O₃ (refractive index n=1.63), La₂O₃ (refractive index n=1.95), ZrO₂ (refractive index n=2.05), and Y₂O₃ (refractive index n=1.87). These particles may be used alone or by mixture thereof. The particles in a colloid form which are dispersed in an organic solvent or water are excellent from the viewpoint of dispersibility. A particle diameter of the particle may be from 1 to 100 nm, preferably from 5 to 20 nm from the viewpoint of transparency of the coating film.

The high refractive index layer may be obtained as follows. After the above-mentioned materials are diluted in a solvent and provided on a substrate by a wet coating method such as spin coating, roll coating or printing, followed by drying, the formed layer is cured by heat, radiation (in the case of an ultraviolet, the above-mentioned photopolymerization initiator is used) or the like.

Also, an UV absorbing agent may be contained in the antireflective layer in terms of providing the ultraviolet shielding function to the antireflective layer.

### <Antiglare Layer>

The antiglare layer (abbreviated as AG layer) is basically roughened on an entrance face of light in order to scatter or diffuse outside light. As a roughening process, there may be a method for roughening a substrate surface directly to form fine concavity and convexity by a sandblast method or an emboss method or the like, a method for providing a roughened layer by applying a coating liquid containing an inorganic filler such as silica or an organic filler such as a resin particle in a resin binder curable with radiation or heat or combination thereof on the substrate surface, and a method for forming a porous film on the substrate surface in a sea-island structure. As a resin of the resin binder, a curable acrylate resin, an ionizing radiation-curable resin similarly as the hard coat layer or the like may be suitably used as surface strength is required as a surface layer.

### <UV Absorbing Layer>

In the present invention, it is preferable that the UV absorbing layer is provided independently from the adhesive layer on the observation side with respect to the adhesive layer to prevent the deterioration of the light absorbing agent in the adhesive layer according to the present invention. The UV absorbing layer may be a layer prepared by adding a UV absorbing agent to another functional layer, thereby acting not only as the UV absorbing layer but also as another functional layer, or an independent layer. As the UV absorbing agent used as the functional layer, the same UV absorbing agent as mentioned in the adhesive layer according to the present invention can be used. As a binder resin used in the case of independent layer, resin such as a polyester resin, a polyurethane resin, an acrylate resin, and an epoxy resin are used. In addition, a dry and curable method of the binder resin includes a dried solidified method by drying solvent (or disperse medium) from solvent (or emulsion), a curing method utilizing polymerization or crosslinking reaction by energy such as heat, ultraviolet light, and electron beam, and a curing method utilizing a reaction such as crosslinkage, polymerization between a functional group such as a hydroxyl group, an epoxy group in the resin and an isocyanate group in the curing agent.

Also, commercial ultraviolet cut filter, for example, “sharp cut filter SC-38”, “sharp cut filter SC-39”, “sharp cut filter SC-40” (product name, manufactured by FUJIFILM Corporation), “Acryplen” (product name, manufactured by MITSUBISHI RAYON Co., Ltd.) and so on can be used.

### <Surface Protective Layer>

The surface protective layer 5 is a layer having a protective function of the surface of composite filter. The surface protective layer can be formed as a transparent resin film and the resin film is preferably formed as a resin cured layer, in which a curable resin is cured from the viewpoint of resistance to scratch and surface contamination. Such a resin cured layer can be formed as a so-called hard coat layer (which may be abbreviated as a HC layer). The surface protective layer may be formed as a single layer as well as multiple layers.

In the case of forming the surface protective layer which is applicable as the hard coat layer, as a curing resin, an ionizing radiation-curable resin, other known curable resin or the like may be accordingly used in accordance with required performance. The ionizing radiation-curable resin includes resins based on acrylate, oxetane, silicone and the like. For example, the acrylate-based ionizing radiation-curable resin may be comprised of a (meth)acrylic ester monomer such as a nonfunctional (meth)acrylate monomer, a difunctional (meth)acrylate monomer, and a (meth)acrylate monomer of trifunctional or more, a (meth)acrylic ester oligomer or a (meth)acrylic ester prepolymer such as urethane (meth)acrylate, epoxy (meth)acrylate, and polyester (meth)acrylate. Further, as the (meth)acrylate monomer of trifunctional or more, there may be trimethylolpropane tri(meth)acrylate, pentaerythritol tetra(meth)acrylate, dipentaerythritol hexa(meth)acrylate or the like.

The surface protective layer may be formed by applying and curing the resin composition containing the curable resin such as the ionizing radiation-curable resin on the surface of the transparent substrate film. As an ionization radiation which cures the ionizing radiation-curable resin, there may be an ultraviolet light, an electron beam or the like. To apply the resin composition of curable resin on the surface of the transparent substrate film, a known coating method or printing method (transferring printing is also included) may be accordingly employed.

A thickness of the surface protective layer may be a thickness capable of protecting a composite filter.

A silicone base compound, a fluorine base compound and so on may be added to the surface protective layer from the viewpoint of improving contamination resistance.

The surface protective layer may be a layer serving mainly as an antifouling layer which is formed for preventing dust or contaminant from attaching or for making easy to remove dust or contaminant caused by environmental pollution or by careless contact with the surface of the composite filter at use. For example, a fluorine-based coat resin, a silicone-based coat agent, a silicone-fluorine-based coat agent or the like may be used, in particular, the silicone-fluorine-based coat agent may be preferably used. A thickness of the antifouling layer is preferably 100 nm or less, more preferably 10 nm or less, even more preferably 5 nm or less. If the thickness of the antifouling layer is more than 100 nm, the layer is excellent in initial contamination resistance, but is inferior in durability. The thickness of the antifouling layer is the most preferably 5 nm or less from the viewpoint of a balance between the contamination resistance and the durability.

The surface protective layer further may have a function of preventing mirror reflection of outside light in addition to the surface protection function. A specific embodiment is using the surface protective layer also as an antiglare layer or antireflective layer. For example, in the case of the antiglare layer, there may be an embodiment in which a light diffusion particle is added in the surface protective layer (if there are plural layers, the particle is added to the upper layer thereof) and an embodiment in which a surface of the surface protective layer is roughened. The light diffusion particle includes an inorganic particle and an organic particle. The inorganic particle includes, for example, silica, and the organic particle includes a resin particle.

To roughen the surface by molding, after or when applying the resin composition for forming the surface protective layer on the surface of the transparent substrate film, or in the case of curing the resin, while the resin has fluidity capable of molding before completely cured, the surface may be molded using a molding sheet or a molding plate.

In the case of the antireflective layer, the surface protective layer (if there are plural layers, the upper layer thereof) may have a refractive index lower than that of the layer located just below it by the method described in the antireflective layer.

### <Adhesive Layer, Transparent Substrate>

The composite filter according to the present invention may also have an adhesive layer comprising other constituents besides the adhesive layer according to the present invention. As an adhesive used for the adhesive layer, an adhesive which has adhesiveness (adhesive force), transparency, coatability and so on, and is preferably undyed, may be accordingly selected from known adhesives. Such an adhesive can be selected from an acrylic adhesive, a rubber-based adhesive, a polyester-based adhesive and so on. The acrylic adhesive is preferable from the viewpoint of adhesiveness and transparency. Also, for example, commercially available double-sided adhesive tapes (for example, product name: CS-9611, manufactured by Nitto Denko Corporation) can be used.

As the transparent substrate used as a support of each functional layer as required, a transparent substrate similar to one described in the electromagnetic wave shielding layer can be used.

As described above, each layer is exemplified and explained. In the case that the composite filter of the present invention is applied on the front face of a plasma display panel, which is a representative usage thereof, it is preferable that a light transmittance in the region of near-infrared light which is generated when the plasma display panel emits with the use of xenon gas emission, that is, in the wavelength of 800 to 1,100 nm, is 30% or less, more preferably 20% or less, and even more preferably 10% or less.

Also, in the case that the composite filter of the present invention is applied on the front face of the plasma display panel, which is a typical usage thereof, it is preferable that a light transmittance of the neon light which is emitted after a neon atom is excited and returns to the ground state when the plasma display panel emits with the use of xenon gas emission, that is, in the wavelength of 570 to 610 nm, is 50% or less, more preferably 40% or less.

It is preferable that all light transmittance is 30% or more in terms of obtaining a composite filter that transparency is high and image contrast decrease is low in the presence of outside light. Herein, the all light transmittance is a value measured with reference to JIS K7361-1.

The composite filter of the present invention has an excellent durability of optical filter function and hardly causes change in spectral characteristics attributable to deterioration of light absorbing agents even after long-term use at high temperature and high humidity. Specifically, both differences (Δx and Δy) in chromaticity (x, y) before and after left in a high temperature (for example, ambient temperature of 80° C. and relative humidity of 10% or less) or in an atmosphere of high temperature and high humidity (for example, ambient temperature of 60° C. and relative humidity of 90%) for 1,000 hours is preferably 0.03 or less, more preferably 0.02 or less.

### {Method for Manufacturing the Composite Filter}

A production method of the composite filter may not be particularly limited. Preferably, a continuous belt-shaped transparent substrate film is prepared and conveyed continuously or intermittently so as to form necessary layers continuously or intermittently. That is, it is preferable to produce the composite filter by a so-called roll to roll process from the viewpoint of productivity. In that case, it is more preferable to produce all laminated layers by a single machine continuously.

Also, the order to form each layer may not be particularly limited and may be decided in accordance with specifications. For example, the order to form each layer may be as follows taking the constitution of the simple filter as an example.

A transparent substrate film is firstly prepared and layers may be formed to the transparent substrate film in the following order:

(A) 1: Formation of a surface protective layer; 2: formation of an electroconductive layer followed by an electroconductive mesh layer; and 3: formation of an adhesive layer;
(B) 1: Formation of an electroconductive layer followed by an electroconductive mesh layer; 2: formation of a surface protective layer; and 3: formation of an adhesive layer; or
(C) 1: Formation of an electroconductive layer; 2: formation of a surface protective layer; 3: formation of a conductive mesh from the electroconductive layer; and 4: formation of an adhesive layer.

When the adhesive layer is formed partially for example for the purpose of exposing an earthing area of the electroconductive mesh layer in production of the composite filter by roll-to-roll processing, partial formation of the adhesive layer is carried out as follows: in the case of an embodiment (form A) wherein the continuous belt-shaped laminate (laminate film having the electroconductive mesh layer laminated on the transparent substrate film) is exposed at one end or both ends thereof in the width direction (in a direction perpendicular to the delivery direction) while the adhesive layer is partially formed as a continuous layer in the longer direction of the laminate (in the delivery direction), the adhesive layer is formed by applying its coating solution in narrower width continuously in the longer direction.

When the adhesive layer is partially formed in the form where the continuous belt-shaped laminate is partially exposed across the full width thereof (form B, that is, the form which is different from the form A by 90° in the lengthwise and crosswise relationship), the adhesive layer is partially formed by applying its coating solution intermittently such that the adhesive layer is not formed in the longer direction so as to expose the corresponding part in the width direction. That is, the coating solution is applied not on the whole area but in a patterned form. Intermittent coating may be carried out not only by a coating method but also by a printing method including transfer, and a suitable method can be selected from methods known in the art.

In the most common form (that is, the form (C)), wherein the electroconductive mesh layer has a mesh area in the center and an earthing area in the form of a frame around the mesh area, and this earthing area is exposed in the form of a frame, the width is made narrow such as in the form A, while intermittent coating is carried out.

The adhesive layer may also be partially formed at a part of the earthing area, generally a part of inner side, which is the side of the mesh area in order to make sure that the mechanically-weak mesh area is protected even if there is some formation displacement.

Then, thus produced continuous belt-shaped composite filter, in which a plurality of one unit of composite filter corresponding to one unit of applicable display continue, may be cut in the form of a sheet for each unit of the composite filter.

III. Display Device

The display device according to the present invention is a display device provided with the optical filter according to the present invention.

The optical filter according to the present invention is suitable to be used by being incorporated in the display device. A method of incorporation may not be limited. Application of the display device may not be particularly limited, but particularly, the display device may be suitably used for a plasma display device which requires various optical filter functions.

Hereinafter, the plasma display will be described as an example.

The plasma display of the present invention comprise the optical filter according to the present invention besides constituents of a general plasma display panel such as a glass substrate, gas, an electrode, an electrode lead material, a thick film printing material, a phosphor and so on, and further a body of equipment. As the glass substrate, two glass substrates consisting of a front-side glass substrate and a back-side glass substrate are used. An electrode and a dielectric layer are formed on the glass substrates, and further a phosphor layer is formed on the back-side glass substrate. The gas such as helium, neon, xenon or the like is filled between the glass substrates. Other constituents and production method of the plasma display may be constituents and methods generally used, thus the explanation is omitted herein.

An example of the plasma display according to the present invention is shown in FIG. 2. The optical filter 10 according to the present invention having the same form and size as the front-side glass is bonded on the front-side glass of a body of the plasma display panel 20 via the adhesive layer 1. In another example of the plasma display according to the present invention, the optical filter according to the present invention having the glass substrate as shown in FIGS. 1 and 3 is disposed without bonding at the front face of the front-side glass of the body of the plasma display panel.

The present invention may not be limited to the above-mentioned embodiments. The above-mentioned embodiments are solely exemplifications. Embodiments having a structure substantially as same as that of the technical idea disclosed in claims of the present invention and provides similar effect are included in the technical scope of the present invention.

### EXAMPLES

Hereinafter, the present invention will be explained further in detail with reference to examples.

### Example 1

As solvents, 25 parts by weight of toluene and 25 parts by weight of methyl ethyl ketone were mixed with 50 parts by weight of a triblock copolymer (product name: LA2140e, manufactured by Kuraray Co., Ltd.) with a (polymethyl methacrylate)-(poly-n-butyl acrylate)-(polymethyl methacrylate) structure having a weight average molecular weight of 80,000 and a molecular weight distribution (Mw/Mn) of 1.17, to prepare a resin solution (s-I).

As a solvent, 50 parts by weight of methyl ethyl ketone was mixed with 50 parts by weight of polymethyl methacrylate having a weight average molecular weight of 15,000 and the glass transition temperature of 102° C., to prepare a resin solution (s-II).

Further, 0.2 parts by weight of Excolor IR12 (a phthalocyanine-based compound) and 0.1 parts by weight of IR14 (a phthalocyanine-based compound) (both of which are product names, manufactured by Nippon Shokubai Co., Ltd.), 0.4 parts by weight of KayasorbIRG-068 (product name, manufactured by Nippon Kayaku Co., Ltd.; a diimmonium-based compound) and 10 parts by weight of methyl ethylketone were mixed to prepare a light absorbing agent solution (s-III).

The above-mentioned resin solution (s-II) and the above-mentioned light absorbing agent solution (s-III) were mixed to prepare a resin solution with light absorbing agent (s-II+III) so that a weight ratio of the solid content of PMMA to the total solid content of light absorbing agents was 7:2.

Next, the above-mentioned resin solution (s-I) and the above-mentioned resin solution with light absorbing agent (s-II+III) were mixed so that a weight ratio of the solid content of triblock copolymer to the solid content of PMMA was 9:1 and sufficiently dispersed, thus an adhesive composition for optical filter of the present invention was prepared.

The adhesive composition was applied with an applicator onto a release-treated PET of 100 μm in thickness (product name: E7002, manufactured by Toyobo Co., Ltd.) such that the thickness of the coating after drying became 25 μm, and then the coating was dried at 80° C. for 3 minutes, and then a release-treated PET of 100 μm in thickness was laminated thereon, whereby an adhesive layer having optical filter functions was obtained.

The adhesive layer in Example 1 was evaluated for its durability, glass adhesion and haze by evaluation methods described later.

As a result, differences Δx and Δy in chromaticity (x, y) of the test sample before and after left for 1,000 hours in a high-temperature atmosphere (ambient temperature 80° C., relative humidity 10% or less) was 0.01 or less and in a high-temperature high-humidity atmosphere (ambient temperature 60° C., relative humidity 90%) was 0.015 or less.

A graph showing amounts of change in ΔE*ab with time in the case of leaving in a high-temperature atmosphere (for example, ambient temperature of 80° C., relative humidity of 10% or less), in which ΔE*ab represents an amount of color variation, is shown in FIG. 5. ΔE*ab is a value which can be obtained by the following formula:

ΔE*ab={(ΔL*)²+(Δa*)²+(Δb*)²}^{1/2}

wherein, ΔL*, Δa* and Δb* respectively refer to the difference of value of L*, a* and b* of the surface of the adhesive layer before and after the layer is left in the specific atmosphere for the specific hours; and L*, a* and b* are values in L*a*b* color system recommended by the International Commission on Illumination (CIE) in 1976 and also defined in JIS Z8729.

All of the glass adhesion of the adhesive layer before and after left for 1,000 hours both in a high-temperature atmosphere (ambient temperature 80° C., relative humidity 10% or less) and in a high-temperature high-humidity atmosphere (ambient temperature 60° C., relative humidity 90%) showed a value in the range of 8 to 12 N/25 mm, while the adhesive did not remain on the surface of the adherend. A haze was 2.5%.

### <Evaluation>

The resulting adhesive layer was attached to a glass plate 32 (a high strain point glass plate (product name: PD-200, thickness 2.8 mm) manufactured by Asahi Glass Co., Ltd. was used as a front glass plate for a display device), and then a PET film (A4100, thickness 50 μm, manufactured by Toyobo Co., Ltd.) was laminated thereonto, thus preparing a test sample.

### (1) Durability

First, the chromaticity (x, y) of the test sample before the durability test was measured. The chromaticity was measured with a spectrophotometer (product name: UV-3100PC, manufactured by Shimadzu Corporation).

### [High-Temperature Durability Test]

The resulting test sample was left for 1,000 hours in a high-temperature atmosphere (ambient temperature 80° C., relative humidity 10% or less) and then measured for its chromaticity (x, y) in the same manner as described above.

From the measured values of the chromaticity (x, y) of the test sample before and after left in the high-temperature atmosphere, differences Δx and Δy in chromaticity (x, y) were determined. [High-temperature and high-humidity durability test]

The resulting test sample was left for 1,000 hours in a high-temperature high-humidity atmosphere (ambient temperature 60° C., relative humidity 90%) and then measured for its chromaticity (x, y) in the same manner as described above.

From the measured values of the chromaticity (x, y) of the test sample before and after left in the high-temperature high-humidity atmosphere, differences Δx and Δy in chromaticity (x, y) were determined.

### (2) Glass Adhesion

The glass adhesion was measured by peeling the PET film and the adhesive layer attached to the glass plate, at a rate of 200 mm/min. at an angle of 90° between the glass plate and the PET film in accordance with a test in JIS Z0237-2000.

### (3) Haze

In accordance with JIS K7105-1981, the haze value was measured using a sample which was made by attaching the adhesive layer to a glass plate with a thickness of 1.2 mm and attaching an easy adhering surface of PET film (product name: Cosmoshine A-4100, manufactured by Toyobo Co., Ltd.) to the adhesive layer on the side opposite to the glass plate so as to laminate the PET film on the adhesive layer.

### Example 2

An adhesive composition was prepared in the same manner as in Example 1 except for using isobornyl polymethacrylate having a weight average molecular weight of 70,000 and a glass transition temperature of 112° C. in place of polymethyl methacrylate having a weight average molecular weight of 15,000 and a glass transition temperature of 102° C. and an adhesive layer having optical filter functions was obtained in the same manner as in Example 1.

The adhesive layer of Example 2 was evaluated for its durability, glass adhesion and haze by the same evaluation method as in Example 1. The result is shown in Table 1.

### Example 3

An adhesive composition was prepared in the same manner as in Example 1 except for using isobornyl polymethacrylate having a weight average molecular weight of 100,000 and a glass transition temperature of 112° C. in place of polymethyl methacrylate having a weight average molecular weight of 15,000 and a glass transition temperature of 102° C. and an adhesive layer having optical filter functions was obtained in the same manner as in Example 1.

The adhesive layer of Example 3 was evaluated for its durability, glass adhesion and haze by the same evaluation method as in Example 1. The result is shown in Table 1.

### Example 4

An adhesive composition was prepared in the same manner as in Example 1 except for using t-butyl polymethacrylate having a weight average molecular weight of 10,000 and a glass transition temperature of 107° C. in place of polymethylmethacrylate having a weight average molecular weight of 15,000 and a glass transition temperature of 102° C. and an adhesive layer having optical filter functions was obtained in the same manner as in Example 1.

The adhesive layer of Example 4 was evaluated for its durability, glass adhesion and haze by the same evaluation method as in Example 1. The result is shown in Table 1.

### Example 5

An adhesive composition was prepared in the same manner as in Example 1 except for using cyclohexyl polymethacrylate having a weight average molecular weight of 65,000 and a glass transition temperature of 104° C. in place of polymethylmethacrylate having a weight average molecular weight of 15,000 and a glass transition temperature of 102° C. and an adhesive layer having optical filter functions was obtained in the same manner as in Example 1.

The adhesive layer of Example 5 was evaluated for its durability, glass adhesion and haze by the same evaluation method as in Example 1. The result is shown in Table 1.

### Example 6

An adhesive composition was prepared in the same manner as in Example 1 except that 50 parts by mass of triblock copolymer (a triblock copolymer having the same linkage structure (polymethylmethacrylate)-(poly-n-butyl acrylate)-(polymethylmethacrylate) as in Example 1, which was polymerized so as to have a weight average molecular weight of 60,000 and a molecular weight distribution (Mw/Mn) of 1.40) was used in place of 50 parts by mass of the triblock copolymer (product name: LA2140e, manufactured by Kuraray Co., Ltd.) in Example 1, and an adhesive layer having optical filter functions was obtained in the same manner as in Example 1.

The adhesive layer in Example 6 was evaluated for its durability, glass adhesion and haze by the same evaluation method as in Example 1. The result is shown in Table 1.

### Example 7

An adhesive composition was prepared in the same manner as in Example 1 except that 50 parts by mass of triblock copolymer (a triblock copolymer having the same linkage structure (polymethylmethacrylate)-(poly-n-butyl acrylate)-(polymethylmethacrylate) as in Example 1, which was polymerized so as to have a weight average molecular weight of 110,000 and a molecular weight distribution (Mw/Mn) of 1.40) was used in place of 50 parts by mass of the triblock copolymer (product name: LA2140e, manufactured by Kuraray Co., Ltd.) in Example 1 and an adhesive layer having optical filter functions was obtained in the same manner as in Example 1.

The adhesive layer in Example 7 was evaluated for its durability, glass adhesion and haze by the same evaluation method as in Example 1. The result is shown in Table 1.

### Example 8

An adhesive composition was prepared in the same manner as in Example 1 except for using an acrylic copolymer containing a methyl methacrylate unit (product name: BR113, manufactured by MITSUBISHI RAYON CO., LTD.; acid number: 3.5) having a weight average molecular weight of 30,000 and a glass transition temperature of 75° C. in place of polymethylmethacrylate having a weight average molecular weight of 15,000 and a glass transition temperature of 102° C. and an adhesive layer having optical filter functions was obtained in the same manner as in Example 1.

The adhesive layer in Example 8 was evaluated for its durability, glass adhesion and haze by the same evaluation method as in Example 1. The result is shown in Table 1.

### Comparative Example 1

As solvents, 25 parts by weight of toluene and 25 parts by weight of methyl ethyl ketone were mixed with 50 parts by weight of a triblock copolymer (product name: LA2140e, manufactured by Kuraray Co., Ltd.) with a (polymethyl methacrylate)-(poly-n-butyl acrylate)-(polymethyl methacrylate) structure having a weight average molecular weight of 80,000 and a molecular weight distribution (Mw/Mn) of 1.17, to prepare a resin solution. As near-infrared light absorbing agents, 0.2 part by weight of Excolor IR12 (phthalocyanine-based compound) and 0.1 part by weight of IR14 (phthalocyanine-based compound) (both of which are product names, manufactured by Nippon Shokubai Co., Ltd.) and 0.4 part by weight of Kayasorb IRG-068 (diimmonium-based compound) (product name, manufactured by Nippon Kayaku Co., Ltd.) were added to, and sufficiently dispersed in, the resin solution, whereby an adhesive composition for optical filter was prepared. The adhesive layer having optical filter functions was obtained in the same manner as in Example 1.

The adhesive layer of Comparative Example 1 was evaluated for its durability, glass adhesion and haze by the same evaluation method as in Example 1. The result is shown in Table 1.

The graph showing amounts of change in ΔE*ab with time in the case of leaving in a high-temperature atmosphere (for example, ambient temperature of 80° C., relative humidity of 10% or less), in which ΔE*ab represents an amount of color variation, is shown in FIG. 5.

### Comparative Example 2

An adhesive composition was prepared in the same manner as in Example 1 except for using a diblock acrylic copolymer (product name: LA1114, manufactured by Kuraray Co., Ltd.) with a (polymethylmethacrylate)-(poly-n-butyl acrylate) structure having a weight average molecular weight of 60,000 and a glass transition temperature of less than −20° C. in place of polymethylmethacrylate having a weight average molecular weight of 15,000 and a glass transition temperature of 102° C., and an adhesive layer having optical filter functions was obtained in the same manner as in Example 1.

The adhesive layer of Comparative Example 2 was evaluated for its durability, glass adhesion and haze by the same evaluation method as in Example 1. The result is shown in Table 1. As the adhesive remained on the surface of the adherend, it was clear that the adhesive layer of Comparative Example 2 did not have a reworkable property.

### Comparative Example 3

An adhesive composition was prepared in the same manner as in Example 1 except that 50 parts by mass of a triblock copolymer (a triblock copolymer having the same linkage structure (polymethylmethacrylate)-(poly-n-butyl acrylate)-(polymethylmethacrylate) as in Example 1, which was polymerized so as to have a weight average molecular weight of 316,400 and a molecular weight distribution (Mw/Mn) of 2.26) was used in place of 50 parts by mass of the triblock copolymer (product name: LA2140e, manufactured by Kuraray Co., Ltd.) in Example 1, and an adhesive layer having optical filter functions was obtained in the same manner as in Example 1.

The adhesive layer of Comparative Example 3 was evaluated for its durability, glass adhesion and haze by the same evaluation method as in Example 1. The result is shown in Table 1.

### Comparative Example 4

An adhesive composition was prepared in the same manner as in Example 1 except that 50 parts by mass of a triblock copolymer (a triblock copolymer having the same linkage structure (polymethylmethacrylate)-(poly-n-butyl acrylate)-(polymethylmethacrylate) as in Example 1, which was polymerized so as to have a weight average molecular weight of 47,000 and a molecular weight distribution (Mw/Mn) of 1.65) was used in place of 50 parts by mass of the triblock copolymer (product name: LA2140e, manufactured by Kuraray Co., Ltd.) in Example 1, and an adhesive layer having optical filter functions was obtained in the same manner as in Example 1.

The adhesive layer of Comparative Example 4 was evaluated for its durability, glass adhesion and haze by the same evaluation method as in Example 1. The result is shown in Table 1.

### Comparative Example 5

An adhesive composition was prepared in the same manner as in Example 1 except that 50 parts by mass of a triblock copolymer (a triblock copolymer having the same linkage structure (polymethylmethacrylate)-(poly-n-butyl acrylate)-(polymethylmethacrylate) as in Example 1, which was polymerized so as to have a weight average molecular weight of 60,000 and a molecular weight distribution (Mw/Mn) of 1.65) was used in place of 50 parts by mass of the triblock copolymer (product name: LA2140e, manufactured by Kuraray Co., Ltd.) in Example 1 and an adhesive layer having optical filter functions was obtained in the same manner as in Example 1.

The adhesive layer of Comparative Example 5 was evaluated for its durability, glass adhesion and haze by the same evaluation method as in Example 1. The result is shown in Table 1.

### Comparative Example 6

An adhesive composition was prepared in the same manner as in Example 1 except that 50 parts by mass of a triblock copolymer (a triblock copolymer having the same linkage structure (polymethylmethacrylate)-(poly-n-butyl acrylate)-(polymethylmethacrylate) as in Example 1, which was polymerized so as to have a weight average molecular weight of 40,000 and a molecular weight distribution (Mw/Mn) of 1.17) was used in place of 50 parts by mass of the triblock copolymer (product name: LA2140e, manufactured by Kuraray Co., Ltd.) in Example 1, and an adhesive layer having optical filter functions was obtained in the same manner as in Example 1.

The adhesive layer of Comparative Example 6 was evaluated for its durability, glass adhesion and haze by the same evaluation method as in Example 1. The result is shown in Table 1.

### Example 9

### (1) Forming of Continuous Belt-Shaped Electromagnetic Wave Shielding Sheet

As a metallic foil for an electroconductive mesh layer, a continuous belt-shaped electrolytic copper foil having a thickness of 10 μm, in which a blackend layer containing copper-cobalt alloy particles was formed by electrolytic plating on one surface, was prepared. After galvanizing both sides of the copper foil, the both sides were subject to a known chromate treatment by dipping so as to form an anticorrosive layer on both sides of the copper foil.

As a transparent resin substrate sheet 11, a continuous belt-shaped colorless, transparent, biaxially-stretched polyethylene terephthalate film having a thickness of 100 μm and having a polyester resin primer layer formed on one surface was prepared.

Next, after the copper foil was dry-laminated on the transparent resin substrate primer layer on the blackened layer side by a transparent two-component curable urethane resin-based adhesive mainly comprising 12 parts by weight of polyester polyurethane polyol having an average molecular weight of 30,000 and, as a curing agent, 1 parts by weight of a xylene diisocyanate-base prepolymer followed by leaving at 50° C. for 3 days, a continuous belt-shaped electromagnetic wave shielding sheet having a transparent adhesive layer with a thickness of 7 μm between the copper foil (the anticorrosive layer) and the transparent resin substrate was obtained.

Next, the electroconductive layer and the blackened layer of the continuous belt-shaped electromagnetic wave shielding sheet were subject to etching using the photolithographic method so as to form an electroconductive mesh layer having a mesh area comprising an opening and a line part and an earthing area surrounding four sides of periphery of the mesh area in the frame form, in which the mesh is not formed.

In the etching, using a production line for a color TV shadow mask, processes from masking to etching was consistently performed on the continuous belt-shaped laminated sheet. Specifically, a resist layer was formed by applying a photosensitive etching resist on the whole surface of the electroconductive layer of the laminate sheet, and then a desired mesh pattern was transferred by contact exposure followed by development, film-hardening treatment and baking, so that the resist layer was processed in a pattern wherein the resist layer remains on the region corresponding to the line part of the mesh and the resist layer does not remain on the region corresponding to the opening of the mesh. Next, the electroconductive layer and the blackened layer were subject to removing etchant by an aqueous ferric chloride solution so as to form a mesh-form opening, followed by water washing, resist stripping, cleaning and drying in this order.

Thus, a continuous belt-shaped electromagnetic wave shielding sheet was obtained.

### (2) Formation of a Surface Protective Layer

A surface protective layer was formed on the whole surface of one side to be a front face of the continuous belt-shaped electromagnetic wave shielding sheet (the transparent substrate film-side surface of the laminate). Specifically, firstly, as an ionizing radiation-curable resin, 100 parts by mass of dipentaerythritol hexaacrylate of an ultraviolet curable resin (manufactured by NIPPON KAYAKU Co., Ltd.), as a light curing initiator, 4.0 parts by mass of Irgacure 184 (product name, manufactured by Nihon Ciba-Geigy K.K) and as a solvent, 52 parts by mass of methylisobutylketone were sufficiently mixed to prepare a coating liquid for forming the surface protective layer. After the coating liquid was intermittently coated on the transparent substrate film surface of the continuous belt-shaped laminate so that the layer thickness was 7 μm by means of a die coater, and the coated layer was dried by heating in an oven at 50° C. Then, the coated layer was cured under N₂ environment (integrating light quantity of 200 mJ) with the use of H bulb of UV irradiation device (manufactured by Fusion UV Systems Japan KK) as a light source. Thus, a single layer of the surface protective layer which was to be used as a hardcoat layer was formed.

### (3) Formation of an Adhesive Layer

Next, with respect to the back face of the continuous belt-shaped laminate in which the surface protective layer (the surface on the electroconductive mesh layer side) was formed, an adhesive layer having several types of dyes added was formed. As the adhesive for forming the adhesive layer, the adhesive composition for an optical filter which was obtained in Example 1 was used.

After the composition was coated on the surface at the electroconductive mesh layer side, which was a back face of the laminate, by means of a die coater so that a thickness was 25 μm, the coated layer was dried at 100° C. for 1 minute in an oven with dried air at the rate of 5 m/sec to form an adhesive layer. Thereby, a continuous belt-shaped composite filter was obtained. In addition, the surface of the adhesive layer was protected by applying a release film which can be removed.

The adhesive layer was partially formed on the electroconductive mesh layer to cover the mesh area and not to cover the earthing area by an intermittent coating method.

Chromaticity (x, y) of the obtained optical filter left in an atmosphere at 80° C. and a relative humidity of 10% or less for 1,000 hours and the obtained optical filter left in an atmosphere at 60° C. and a relative humidity of 90% for 1,000 hours were respectively measured. The differences (Δx and Δy) from the initial values were less than 0.015 respectively in the atmosphere at 80° C. and a relative humidity of 10% or less and in the atmosphere at 60° C. and a relative humidity of 90%.

TABLE 1

| | Triblock | | | | | | | | | |
|---|---|---|---|---|---|---|---|---|---|---|
| | Copolymer | | Resin(II) or Resin(IV) | | 80° C., 90% | | 60° C., 90% | | Glass Adehsion | Haze |
| | Mw | Mw/Mn | Resin Type | Tg (° C.) | Δx | Δy | Δx | Δy | (N/25 mm) | (%) |
| Example 1 | 80,000 | 1.17 | polymethyl methacrylate | 102 | 0.01 | 0.01 | 0.015 | 0.015 | 8 to 12 | 2.5 |
| Example 2 | 80,000 | 1.17 | poly(isobornyl-methacylate) | 112 | 0.01 | 0.01 | 0.015 | 0.015 | 8 to 12 | 2.5 |
| Example 3 | 80,000 | 1.17 | poly(isobornyl-methacylate) | 112 | 0.01 | 0.01 | 0.015 | 0.015 | 8 to 12 | 3.0 |
| Example 4 | 80,000 | 1.17 | poly-t-butyl-methacrylate | 107 | 0.01 | 0.01 | 0.015 | 0.015 | 8 to 12 | 3.5 |
| Example 5 | 80,000 | 1.17 | poly(cyclohexyl methacylate) | 104 | 0.01 | 0.01 | 0.015 | 0.015 | 8 to 12 | 3.8 |
| Example 6 | 60,000 | 1.40 | polymethyl methacrylate | 102 | 0.01 | 0.01 | 0.015 | 0.015 | 8 to 12 | 3.0 |
| Example 7 | 110,000 | 1.40 | polymethyl methacrylate | 102 | 0.01 | 0.01 | 0.015 | 0.015 | 8 to 12 | 3.0 |
| Example 8 | 80,000 | 1.17 | acrylic copolymer | 75 | 0.01 | 0.01 | 0.015 | 0.015 | 8 to 12 | 2.5 |
| | | | containing polymethyl | | | | | | | |
| | | | methacrylate | | | | | | | |
| Comparative | 80,000 | 1.17 | — | — | 0.02 | 0.02 | 0.02 | 0.02 | 10 to 15 | 1.6 |
| Example 1 | | | | | | | | | | |
| Comparative | 80,000 | 1.17 | diblock acrylic copolymer | −20 | above | above | above | above | 13 to 16 | 2.0 |
| Example 2 | | | | | 0.03 | 0.03 | 0.03 | 0.03 | (adhesive remained) | |
| Comparative | 316,400 | 2.26 | polymethyl methacrylate | 102 | above | above | above | above | less than 5 | 2.4 |
| Example 3 | | | | | 0.03 | 0.04 | 0.03 | 0.03 | | |
| Comparative | 47,000 | 1.65 | polymethyl methacrylate | 102 | above | above | above | above | 30 or more | 2.4 |
| Example 4 | | | | | 0.03 | 0.05 | 0.03 | 0.03 | | |
| Comparative | 60,000 | 1.65 | polymethyl methacrylate | 102 | above | above | above | above | 10 to 15 | 2.1 |
| Example 5 | | | | | 0.03 | 0.06 | 0.03 | 0.03 | | |
| Comparative | 47,000 | 1.17 | polymethyl methacrylate | 102 | above | above | above | above | 8 to 12 | 2.1 |
| Example 6 | | | | | 0.03 | 0.07 | 0.03 | 0.03 | | |

1. An adhesive composition for optical filter, comprising:
(I) a multiblock copolymer having, in its molecule, at least a triblock structure wherein one polymer block (A1) containing acrylic ester units, and two polymer blocks (B1) different in structure from the polymer block (A1) and containing (meth)acrylic ester units, are bound to one another, or a triblock structure wherein two polymer blocks (A1) containing acrylic ester units, and one polymer block (B1) different in structure from the polymer block (A1) and containing (meth)acrylic ester units, are bound to one another, and having a weight average molecular weight of 50,000 or more and a molecular weight distribution (Mw/Mn) of less than 1.5;
(II) a resin; and
(III) one or more light absorbing agents each having light absorption in a predetermined wavelength range,
wherein the resin (II) makes 0.015 or less both chromatic differences Δx and Δy of a film consisting of the adhesive composition, before and after left in an atmospheric environment at an ambient temperature of 80° C. and a relative humidity of 10% or less for 1,000 hours.

2. An adhesive composition for optical filter, comprising:
(I) a multiblock copolymer having, in its molecule, at least a triblock structure wherein one polymer block (A1) containing acrylic ester units, and two polymer blocks (B1) different in structure from the polymer block (A1) and containing (meth)acrylic ester units, are bound to one another, or a triblock structure wherein two polymer blocks (A1) containing acrylic ester units, and one polymer block (B1) different in structure from the polymer block (A1) and containing (meth)acrylic ester units, are bound to one another, and having a weight average molecular weight of 50,000 or more and a molecular weight distribution (Mw/Mn) of less than 1.5;
(IV) a resin having a glass transition temperature of 60° C. or more; and
(III) one or more light absorbing agents each having light absorption in a predetermined wavelength range.

3. The adhesive composition for optical filter according to claim 1, wherein from 3 to 50 parts by weight of the resin (II) is contained with respect to 100 parts by weight of the multiblock copolymer (I).

4. The adhesive composition for optical filter according to claim 1, wherein the adhesive composition contains a light absorbing agent having an absorption band region at least in the wavelength from 800 to 1,100 nm.

5. The adhesive composition for optical filter according to claim 1, wherein the light absorbing agent having the absorption band region at least in the wavelength from 800 to 1,100 nm is a phthalocyanine-based compound and/or a diimmonium-based compound.

6. The adhesive composition for optical filter according to claim 1, wherein the resin (II) satisfies 5% or less of haze value in accordance with JIS K7105-1981 of a coating film with a film thickness of 25 μm formed of a mixture mixed in a range from 3 to 50 parts by weight of the resin (II) with respect to 100 parts by weight of the multiblock copolymer (I).

7. The adhesive composition for optical filter according to claim 1, wherein an acid number of the resin (II) is 30 or less.

8. The adhesive composition for optical filter according to claim 1, wherein the resin (II) is one or more resins selected from the group consisting of an acrylic resin, an ester resin, an acrylic ester resin, a styrene resin, a polyvinyl resin and a polycarbonate resin.

9. The adhesive composition for optical filter according to claim 1, wherein the resin (II) is a resin having a (meth)acrylic ester unit which forms a block structure of the multiblock copolymer (I).

10. The adhesive composition for optical filter according to claim 1, wherein the adhesive composition contains a light absorbing agent having an absorption band region at least in the wavelength from 570 to 610 nm.

11. The adhesive composition for optical filter according to claim 1, wherein the adhesive composition contains a light absorbing agent having an absorption band region at least in the wavelength from 380 to 570 nm or 610 to 780 nm.

12.-17. (canceled)

18. The adhesive composition for optical filter according to claim 2, wherein from 3 to 50 parts by weight of the resin (IV) having the glass transition temperature of 60° C. or more are contained with respect to 100 parts by weight of the multiblock copolymer (I).

19. The adhesive composition for optical filter according to claim 2, wherein the adhesive composition contains a light absorbing agent having an absorption band region at least in the wavelength from 800 to 1,100 nm.

20. The adhesive composition for optical filter according to claim 2, wherein the light absorbing agent having the absorption band region at least in the wavelength from 800 to 1,100 nm is a phthalocyanine-based compound and/or a diimmonium-based compound.

21. The adhesive composition for optical filter according to claim 2, wherein the resin (IV) having the glass transition temperature of 60° C. or more satisfies 5% or less of haze value in accordance with JIS K7105-1981 of a coating film with a film thickness of 25 μm formed of a mixture mixed in a range from 3 to 50 parts by weight of the resin (IV) having the glass transition temperature of 60° C. or more with respect to 100 parts by weight of the multiblock copolymer (I).

22. The adhesive composition for optical filter according to claim 2, wherein an acid number of the resin (IV) having the glass transition temperature of 60° C. or more is 30 or less.

23. The adhesive composition for optical filter according to claim 2, wherein the resin (IV) having the glass transition temperature of 60° C. or more is one or more resins selected from the group consisting of an acrylic resin, an ester resin, an acrylic ester resin, a styrene resin, a polyvinyl resin and a polycarbonate resin.

24. The adhesive composition for optical filter according to claim 2, wherein the resin (IV) having the glass transition temperature of 60° C. or more is a resin having a (meth)acrylic ester unit which forms a block structure of the multiblock copolymer (I).

25. The adhesive composition for optical filter according to claim 2, wherein the adhesive composition contains a light absorbing agent having an absorption band region at least in the wavelength from 570 to 610 nm.

26. The adhesive composition for optical filter according to claim 2, wherein the adhesive composition contains a light absorbing agent having an absorption band region at least in the wavelength from 380 to 570 nm or 610 to 780 nm.

27. An optical filter for being disposed on the front face of a display device comprising an adhesive layer having optical filter function formed with the use of the adhesive composition for optical filter defined by claim 1.

28. The optical filter according to claim 27, wherein one or more functional layers having one or more functions selected from the group consisting of an electromagnetic wave shielding function, an antireflection function, an antiglare function, a light absorption function and a surface protection function are laminated on the adhesive layer having the optical filter function.

29. The optical filter according to claim 27, wherein a transmittance in the wavelength from 800 to 1,100 nm is 30% or less.

30. The optical filter according to claim 27, wherein a transmittance of the maximum absorption wavelength in the wavelength range from 560 to 630 nm is 30% or less.

31. The optical filter according to claim 27, wherein all light transmittance is 30% or more.

32. An optical filter for being disposed on the front face of a display device comprising an adhesive layer having optical filter function formed with the use of the adhesive composition for optical filter defined by claim 2.

33. The optical filter according to claim 32, wherein one or more functional layers having one or more functions selected from the group consisting of an electromagnetic wave shielding function, an antireflection function, an antiglare function, a light absorption function and a surface protection function are laminated on the adhesive layer having the optical filter function.

34. The optical filter according to claim 32, wherein a transmittance in the wavelength from 800 to 1,100 nm is 30% or less.

35. The optical filter according to claim 32, wherein a transmittance of the maximum absorption wavelength in the wavelength range from 560 to 630 nm is 30% or less.

36. The optical filter according to claim 32, wherein all light transmittance is 30% or more.

37. A display device provided with the optical filter defined by claim 27.

38. A display device provided with the optical filter defined by claim 32.
